(19) United States
(12) Patent Application Publication
(10) Pub. No.: US 2008/0231627 A1
(43) Pub. Date: Sep. 25, 2008

(54) Using Ray Tracing to Enhance Artificial Intelligence Character Behavior

(76) Inventor: Robert Allen Shearer, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/688,329

(22) Filed: Mar. 20, 2007

(51) Int. Cl. G06T 15/00

(52) U.S. Cl. 345/419

(57) ABSTRACT

Embodiments of the invention provide use ray-tracing to simulate vision for a artificial intelligence controlled character within a three-dimensional scene. According to one embodiment of the invention, an artificial intelligence system may cast rays into the three-dimensional scene from a viewpoint of the character and may perform ray-tracing with the rays to determine if objects are within a field of view of the character. Furthermore, according to embodiments of the invention, the artificial intelligence system may determine behavior for the character based on whether or not objects are within the field of view, and may determine the behavior for the character based on the objects which are within the field of view.

### BACKGROUND OF THE INVENTION

1. Field of the Invention

Embodiments of the invention generally relate to the field of computer processing.

2. Description of the Related Art

Artificial intelligence systems commonly perform tasks to realistically simulate human decision making processes. For example, artificial intelligence is commonly used to control the behavior of non-player characters. Non-player characters are characters in a simulated environment (e.g., a game system) whose behavior is wholly or in-part determined by artificial intelligence.

Artificial intelligence may control behavior of a character in response to objects or other characters in a scene. For example, the artificial intelligence which controls a character may be aware of other objects (e.g., other characters) within a three-dimensional scene. Artificial intelligence may be aware or know the location of other objects via a data structure used to store locations of objects within the three-dimensional scene. Based on that knowledge, the artificial intelligence may determine the behavior of a character in response to the objects. For example, the artificial intelligence may determine that the controlled character may proceed towards an object, or the artificial intelligence may determine that the character may move away from an object.

In some circumstances, the artificial intelligence may base character behavior the location of an object or objects regardless of the proximity of the character to the object or objects. This may result in the artificial intelligence controlling character behavior in ways which are not realistic. For example, artificial intelligence may direct a character to move towards an object a large distance away, even though the character has no way of realistically knowing the location of the object other than a data structure which indicates the location of objects within the three-dimensional scene. This may result in an artificial-intelligence-controlled character behaving in a non human-like way. Consequently, current artificial intelligence systems may lack realism when simulating character behavior. Therefore, there exists a need for more efficient techniques and devices for artificial intelligence to realistically simulate character behavior.

### SUMMARY OF THE INVENTION

Embodiments of the present invention generally provide methods and apparatus for artificial intelligence to control character behavior.

According to one embodiment of the invention, a method of using ray-tracing for artificial intelligence is provided. The method generally comprising: issuing an initial plurality of rays into a three-dimensional scene from a viewpoint of a character; tracing the initial plurality of rays through the three-dimensional scene; and controlling the behavior of the character based on results of tracing the initial plurality of rays through the three-dimensional scene.

According to another embodiment of the invention, a computer readable medium containing a program is provided. The program which, when executed, performs operations generally comprising: issuing an initial plurality of rays into a three-dimensional scene from a viewpoint of a character; tracing the initial plurality of rays through the three-dimensional scene; and controlling the behavior of the character based on results of tracing the initial plurality of rays through the three-dimensional scene.

According to another embodiment of the invention, artificial intelligence system is provided. The artificial intelligence system generally comprising: a memory device containing a spatial index having nodes corresponding to bounding volumes which partition a three-dimensional scene; and a processing element configured to issue an initial plurality of rays into the three-dimensional scene from a viewpoint of a character, trace the initial plurality of rays through the three-dimensional scene; and control the behavior of the character based on results of tracing the initial plurality of rays through the three-dimensional scene.

### BRIEF DESCRIPTION OF THE DRAWINGS

FIGS. 1, 5 and 17 illustrate multiple core processing elements, according to embodiments of the invention.

FIG. 2 illustrates multiple core processing element networks, according to embodiments of the invention.

FIG. 3 is an exemplary three-dimensional scene to be rendered by an image processing system, according to one embodiment of the invention.

FIGS. 4A-4C illustrate a two-dimensional space to be rendered by an image processing system and a corresponding spatial index created by an image processing system, according to embodiments of the invention.

FIG. 6 illustrates an exemplary three-dimensional scene to be rendered by an image processing system, according to embodiments of the invention.

FIG. 7 illustrates a scene graph, according to one embodiment of the invention.

FIG. 8 illustrates a three-dimensional scene to be rendered by an image processing system and a corresponding spatial index, according to one embodiment of the invention.

FIGS. 9, 11 and 15 illustrate integrated acceleration data structures, according to embodiments of the invention.

FIG. 10 illustrates a three-dimensional scene to be rendered by an image processing system, according to one embodiment of the invention.

FIGS. 12, 13, and 16 illustrate exemplary three-dimensional scenes, according to embodiments of the invention.

FIG. 14 is a flowchart illustrating an exemplary method of performing box casting, according to one embodiment of the invention.

FIG. 18 is a flowchart illustrating an exemplary method of using ray-tracing to enhance artificial intelligence character behavior, according to one embodiment of the invention.

FIGS. 19 and 21 illustrate exemplary three-dimensional scenes containing objects, according to embodiments of the invention.

FIGS. 20 and 22 are exemplary grids of blocks which may make up a portion of a field of view, according to embodiments of the invention.

### DETAILED DESCRIPTION OF THE PREFERRED EMBODIMENTS

Embodiments of the invention provide methods and apparatus for artificial intelligence to control character behavior. According to embodiments of the invention, an artificial intelligence system (hereinafter AIS) may use ray-tracing to simulate vision for a character within a three-dimensional scene. The AIS may cast rays from a viewpoint of a character into a three-dimensional scene and perform ray-tracing with the rays to determine what objects are within a field of view of the character. Based on the objects which are within the field of view of the character, the AIS may determine a behavior or response for the character. By determining a response for a character based on the objects which are within the field of view of the character, an AIS may realistically simulate human-like behavior.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### An Exemplary Processor Layout and Communications Network

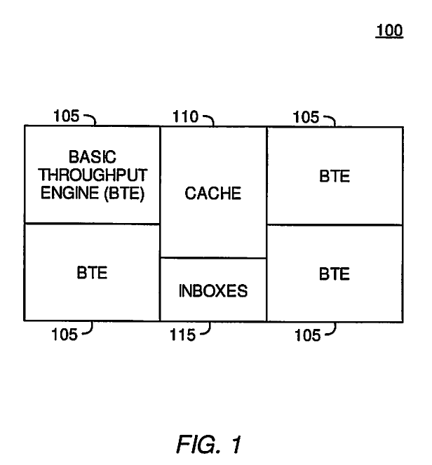

FIG. 1 illustrates a multiple core processing element 100, according to one embodiment of the invention. The multiple core processing element 100 includes a plurality of basic throughput engines 105 (BTEs). A BTE 105 may contain a plurality of processing threads and a core cache (eg., an L1 cache). The processing threads located within each BTE may have access to a shared multiple core processing element cache 110 (e.g., an L2 cache).

The BTEs 105 may also have access to a plurality of inboxes 115. The inboxes 115 may be memory mapped address space. The inboxes 115 may be mapped to the processing threads located within each of the BTEs 105. Each thread located within the BTEs may have a memory mapped inbox and access to all of the other memory mapped inboxes 115. The inboxes 115 make up a low latency and high bandwidth communications network used by the BTEs 105.

The BTEs may use the inboxes 115 as a network to communicate with each other and redistribute data processing work amongst the BTEs. For some embodiments, separate outboxes may be used in the communications network, for example, to receive the results of processing by BTEs 105. For other embodiments, inboxes 115 may also serve as outboxes, for example, with one BTE 105 writing the results of a processing function directly to the inbox of another BTE 105 that will use the results.

The aggregate performance of an image processing system may be tied to how well the BTEs can partition and redistribute work. The network of inboxes 115 may be used to collect and distribute work to other BTEs without corrupting the shared multiple core processing element cache 110 with BTE communication data packets that have no frame to frame coherency. An image processing system which can render many millions of triangles per frame may include many BTEs 105 connected in this manner.

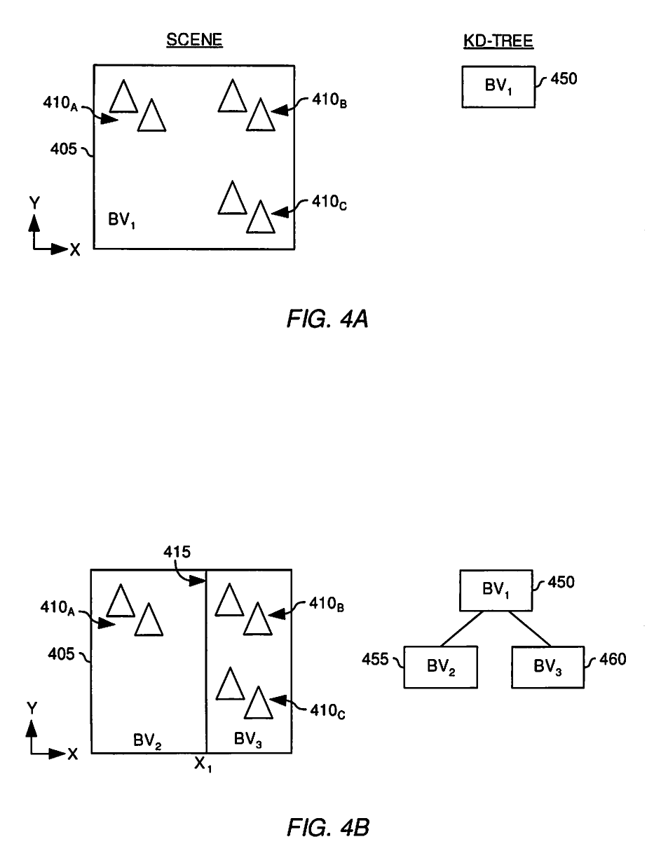

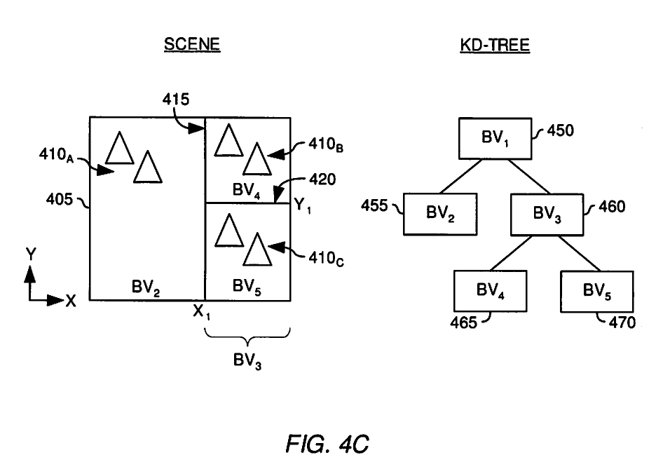

In one embodiment of the invention, the threads of one BTE 105 may be assigned to a workload manager. An image processing system may use various software and hardware components to render a two-dimensional image from a three-dimensional scene. According to one embodiment of the invention, an image processing system may use a workload manager to traverse a spatial index with a ray issued by the image processing system. A spatial index, as described further below with regards to FIG. 4, may be implemented as a tree type data structure used to partition a relatively large three-dimensional scene into smaller bounding volumes. An image processing system using a ray tracing methodology for image processing may use a spatial index to quickly determine ray-bounding volume intersections. In one embodiment of the invention, the workload manager may perform ray-bounding volume intersection tests by using the spatial index.

In one embodiment of the invention, other threads of the multiple core processing element BTEs 105 on the multiple core processing element 100 may be vector throughput engines. After a workload manager determines a ray-bounding volume intersection, the workload manager may issue (send), via the inboxes 115, the ray to one of a plurality of vector throughput engines. The vector throughput engines may then determine if the ray intersects a primitive contained within the bounding volume. The vector throughput engines may also perform operations relating to determining the color of the pixel through which the ray passed.

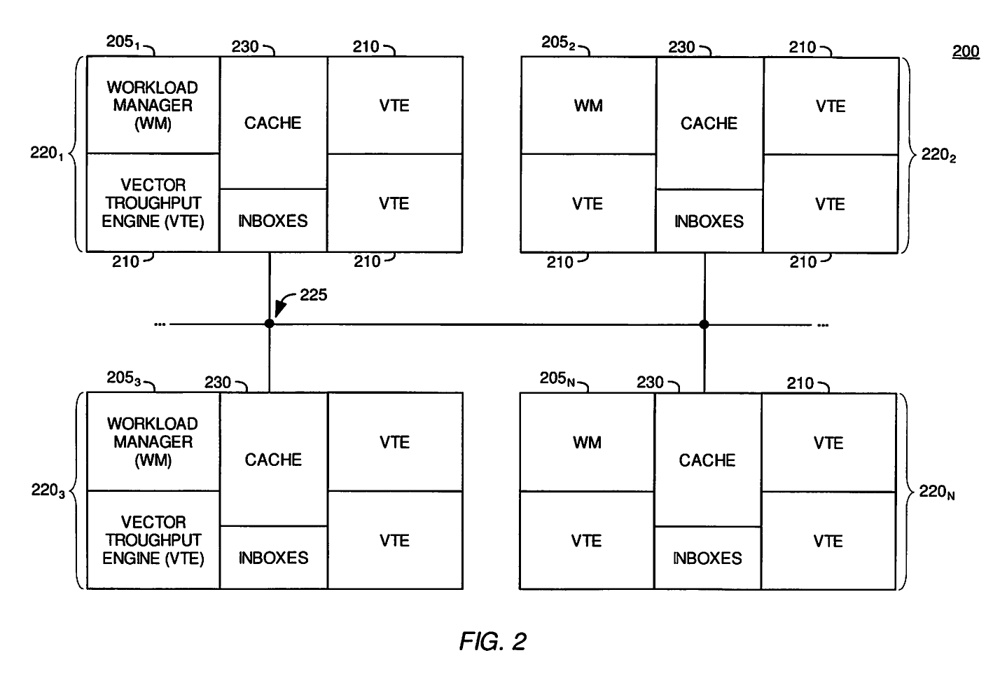

FIG. 2 illustrates a network of multiple core processing elements 200, according to one embodiment of the invention. FIG. 2 also illustrates one embodiment of the invention where the threads of one of the BTEs of the multiple core processing element 100 is a workload manager 205. Each multiple core processing element 220_{1-N} in the network of multiple core processing elements 200 may contain one workload manager 205_{1-N}, according to one embodiment of the invention. Each multiple core processing element 220_{1-N} in the network of multiple core processing elements 200 may also contain a plurality of vector throughput engines 210, according to one embodiment of the invention.

The workload managers 205_{1-N} may use a high speed bus 225 to communicate with other workload managers 205_{1-N} and/or vector throughput engines 210 of other multiple core processing elements 220_{1-N}, according to one embodiment of the invention. Each of the vector throughput engines 210 may use the high speed bus 225 to communicate with other vector throughput engines 210 or the workload managers 205_{1-N}. The workload manager processors 205 may use the high speed bus 225 to collect and distribute image processing related tasks to other workload managers 205_{1-N}, and/or distribute tasks to other vector throughput engines 210. The use of a high speed bus 225 may allow the workload managers 205_{1-N} to communicate without affecting the caches 230 with data packets related to workload manager communications.

### An Exemplary Three-Dimensional Scene

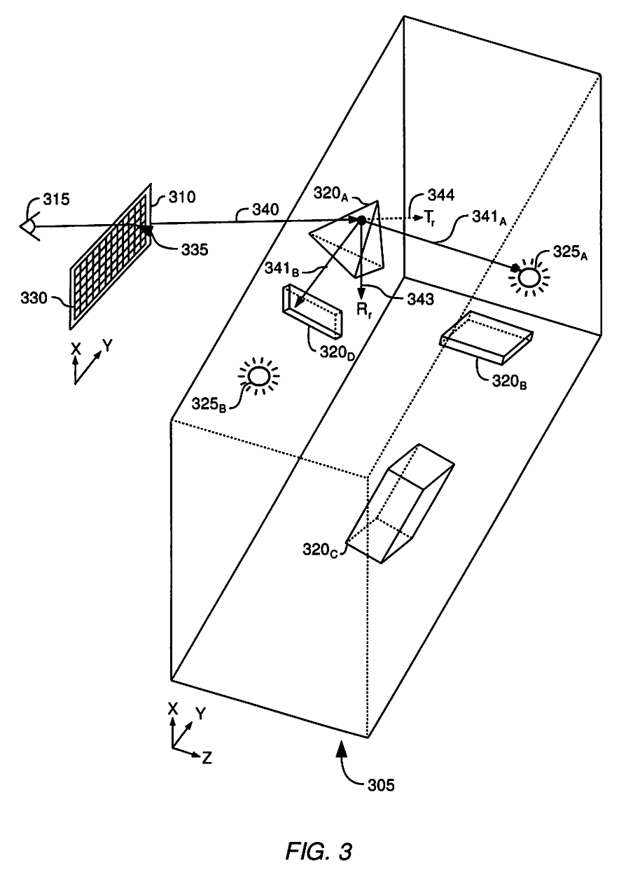

FIG. 3 is an exemplary three-dimensional scene 305 to be rendered by an image processing system. Within the three-dimensional scene 305 may be objects 320. The objects 320 in FIG. 3 are of different geometric shapes. Although only four objects 320 are illustrated in FIG. 3, the number of objects in a typical three-dimensional scene may be more or less. Commonly, three-dimensional scenes will have many more objects than illustrated in FIG. 3.

As can be seen in FIG. 3 the objects are of varying geometric shape and size. For example, one object in FIG. 3 is a pyramid 320_{A}. Other objects in FIG. 3 are boxes 320_{B-D}. In many modern image processing systems objects are often broken up into smaller geometric shapes (e.g., squares, circles, triangles, etc.). The larger objects are then represented by a number of the smaller simple geometric shapes. These smaller geometric shapes are often referred to as primitives.

Also illustrated in the scene 305 are light sources 325_{A-B}. The light sources may illuminate the objects 320 located within the scene 305. Furthermore, depending on the location of the light sources 325 and the objects 320 within the scene 305, the light sources may cause shadows to be cast onto objects within the scene 305.

The three-dimensional scene 305 may be rendered into a two-dimensional picture by an image processing system. The image processing system may also cause the two-dimensional picture to be displayed on a monitor 310. The monitor 310 may use a grid of pixels 330 of different colors to render the final two-dimensional picture.

One method used by image processing systems to render a three-dimensional scene 305 into a two-dimensional picture is called ray tracing. Ray tracing is accomplished by the image processing system “issuing” or “shooting” rays from the perspective of a viewer 315 into the three-dimensional scene 320. The rays have properties and behavior similar to light rays.

One ray 340, that originates at the position of the viewer 315 and traverses through the three-dimensional scene 305, can be seen in FIG. 3. As the ray 340 traverses from the viewer 315 to the three-dimensional scene 305, the ray 340 passes through a plane where the final two-dimensional picture will be rendered by the image processing system. In FIG. 3 this plane is represented by the monitor 310. The point the ray 340 passes through the plane, or monitor 310, is represented by a pixel 335.

As briefly discussed earlier, most image processing systems use a grid 330 of thousands (if not millions) of pixels to render the final scene on the monitor 310. The grid 330 may be referred to as a frame. Each individual pixel may display a different color to render the final composite two-dimensional picture on the monitor 310. An image processing system using a ray tracing image processing methodology to render a two-dimensional picture from a three-dimensional scene will calculate the colors that the issued ray or rays encounters in the three-dimensional scene. The image processing scene will then assign the colors encountered by the ray to the pixel through which the ray passed on its way from the viewer to the three-dimensional scene.

The number of rays issued per pixel may vary. Some pixels may have many rays issued for a particular scene to be rendered. In which case the final color of the pixel is determined by the each color contribution from all of the rays that were issued for the pixel. Other pixels may only have a single ray issued to determine the resulting color of the pixel in the two-dimensional picture. Some pixels may not have any rays issued by the image processing system, in which case their color may be determined, approximated or assigned by algorithms within the image processing system.

To determine the final color of the pixel 335 in the two-dimensional picture, the image processing system must determine if the ray 340 intersects an object within the scene. If the ray does not intersect an object within the scene it may be assigned a default background color (e.g., blue or black, representing the day or night sky). Conversely, as the ray 340 traverses through the three-dimensional scene 305 the ray 340 may strike objects. As the rays strike objects within the scene, the color of the object may be assigned to the pixel through which the ray passes. However, the color of the object must be determined before it is assigned to the pixel.

Many factors may contribute to the color of the object struck by the original ray 340. For example, light sources within the three-dimensional scene may illuminate the object. Furthermore, physical properties of the object may contribute to the color of the object. For example, if the object is reflective or transparent, other non-light source objects may then contribute to the color of the object.

In order to determine the effects from other objects within the three-dimensional scene, secondary rays may be issued from the point where the original ray 340 intersected the object. For example, shadow rays 341 may be issued to determine the contribution of light to the point where the original ray 340 intersected the object. If the object has translucent properties, the image processing system may issue a transmitted or a refracted ray 344 to determine what color or light to be transmitted through the body of the object. If the object has reflective properties, the image processing system may issue a reflected ray to determine what color or light is reflected onto the object 320.

One type of secondary ray may be a shadow ray. Each shadow ray may be traced from the point of intersection of the original ray and the object, to a light source within the three-dimensional scene 305. If the ray reaches the light source without encountering another object before the ray reaches the light source, then the light source will illuminate the object struck by the original ray at the point where the original ray struck the object.

For example, shadow ray 341_{A} may be issued from the point where original ray 340 intersected the object 320_{A}, and may traverse in a direction towards the light source 325_{A}. The shadow ray 341_{A} reaches the light source 325_{A} without encountering any other objects 320 within the scene 305. Therefore, the light source 325_{A} will illuminate the object 320_{A} at the point where the original ray 340 intersected the object 320_{A}.

Other shadow rays may have their path between the point where the original ray struck the object and the light source blocked by another object within the three-dimensional scene. If the object obstructing the path between the point on the object the original ray struck and the light source is opaque, then the light source will not illuminate the object at the point where the original ray struck the object. Thus, the light source may not contribute to the color of the original ray and consequently neither to the color of the pixel to be rendered in the two-dimensional picture. However, if the object is translucent or transparent, then the light source may illuminate the object at the point where the original ray struck the object.

For example, shadow ray 341_{B} may be issued from the point where the original ray 340 intersected with the object 320_{A}, and may traverse in a direction towards the light source 325_{B}. In this example, the path of the shadow ray 341_{B} is blocked by an object 320_{D}. If the object 320_{D} is opaque, then the light source 325_{B} will not illuminate the object 320_{A} at the point where the original ray 340 intersected the object 320_{A}. However, if the object 320_{D} which the shadow ray is translucent or transparent the light source 325_{B} may illuminate the object 320_{A} at the point where the original ray 340 intersected the object 320_{A}.

Another type of secondary ray is a transmitted or refracted ray. A refracted ray may be issued by the image processing system if the object with which the original ray intersected has transparent or translucent properties (e.g., glass). A refracted ray traverses through the object at an angle relative to the angle at which the original ray struck the object. For example, refracted ray 344 is seen traversing through the object 320_{A} which the original ray 340 intersected.

Another type of secondary ray is a transmitted or a refracted ray. If the object with which the original ray intersected has reflective properties (e.g. a metal finish), then a reflected ray will be issued by the image processing system to determine what color or light may be reflected onto the object. Reflected rays traverse away from the object at an angle relative to the angle at which the original ray intersected the object. For example, reflected ray 343 may be issued by the image processing system to determine what color or light may be reflected onto the object 320_{A} which the original ray 340 intersected.

The total contribution of color and light of all secondary rays (e.g., shadow rays, transmitted rays, reflected rays, etc.) will result in the final color of the pixel through which the original ray passed.

### An Exemplary KD-Tree

One problem encountered when performing ray tracing is determining quickly and efficiently if an issued ray intersects any objects within the scene to be rendered. One methodology known by those of ordinary skill in the art to make the ray intersection determination more efficient is to use a spatial index. A spatial index divides a three-dimensional scene or world into smaller volumes (smaller relative to the entire three-dimensional scene) which may or may not contain primitives. An image processing system can then use the known boundaries of these smaller volumes to determine if a ray may intersect primitives contained within the smaller volumes. If a ray does intersect a volume containing primitives, then a ray intersection test can be run using the trajectory of the ray against the known location and dimensions of the primitives contained within that volume. If a ray does not intersect a particular volume, then there is no need to run ray-primitive intersection tests against the primitives contained within that volume. Furthermore, if a ray intersects a bounding volume which does not contain primitives then there is no need to run ray-primitive intersections tests against that bounding volume. Thus, by reducing the number of ray-primitive intersection tests which may be necessary, the use of a spatial index greatly increases the performance of a ray tracing image processing system. Some examples of different spatial index acceleration data structures are octrees, k dimensional Trees (kd-Trees), and binary space partitioning trees (BSP trees). While several different spatial index structures exist, for ease of describing embodiments of the present invention, a kd-Tree will be used in the examples to follow. However, those skilled in the art will readily recognize that embodiments of the invention may be applied to any of the different types of spatial indexes.

A kd-Tree uses axis aligned bounding volumes to partition the entire scene or space into smaller volumes. That is, the kd-Tree may divide a three-dimensional space encompassed by a scene through the use of splitting planes which are parallel to known axes. The splitting planes partition a larger space into smaller bounding volumes. Together the smaller bounding volumes make up the entire space in the scene. The determination to partition (divide) a larger bounding volume into two smaller bounding volumes may be made by the image processing system through the use of a kd-tree construction algorithm.

One criterion for determining when to partition a bounding volume into smaller volumes may be the number of primitives contained within the bounding volume. That is, as long as a bounding volume contains more primitives than a predetermined threshold, the tree construction algorithm may continue to divide volumes by drawing more splitting planes. Another criterion for determining when to partition a bounding volume into smaller volumes may be the amount of space contained within the bounding volume. Furthermore, a decision to continue partitioning the bounding volume may also be based on how many primitives may be intersected by the plane which creates the bounding volume.

The partitioning of the scene may be represented by a binary tree structure made up of nodes, branches and leaves. Each internal node within the tree may represent a relatively large bounding volume, while the node may contain branches to sub-nodes which may represent two relatively smaller partitioned volumes resulting after a partitioning of the relatively large bounding volume by a splitting plane. In an axis-aligned kd-Tree, each internal node may contain only two branches to other nodes. The internal node may contain branches (i.e., pointers) to one or two leaf nodes. A leaf node is a node which is not further sub-divided into smaller volumes and contains pointers to primitives. An internal node may also contain branches to other internal nodes which are further sub-divided. An internal node may also contain the information needed to determine along what axis the splitting plane was drawn and where along the axis the splitting plane was drawn.

### Exemplary Bounding Volumes

FIGS. 4A-4C illustrate a two-dimensional space to be rendered by an image processing system and a corresponding kd-tree. For simplicity, a two-dimensional scene is used to illustrate the building of a kd-Tree, however kd-Trees may also be used to represent three-dimensional scenes. In the two-dimensional illustration of FIGS. 4A-4C splitting lines are illustrated instead of splitting planes, and bounding areas are illustrated instead of bounding volumes as would be used in a three-dimensional structure. However, one skilled in the art will quickly recognize that the concepts may easily be applied to a three-dimensional scene containing objects.

FIG. 4A illustrates a two-dimensional scene 405 containing primitives 410 to be rendered in the final picture to be displayed on a monitor 310. The largest volume which represents the entire volume of the scene is encompassed by bounding volume 1 (BV₁). In the corresponding kd-Tree this may be represented by the top level node 450, also known as the root or world node. In one embodiment of an image processing system, an image processing system may continue to partition bounding volumes into smaller bounding volumes when the bounding volume contains, for example, more than two primitives. As noted earlier the decision to continue partitioning a bounding volume into smaller bounding volumes may be based on many factors, however for ease of explanation in this example the decision to continue partitioning a bounding volume is based only on the number of primitives. As can be seen in FIG. 4A, BV₁ contains six primitives, therefore kd-Tree construction algorithm may partition BV₁ into smaller bounding volumes.

FIG. 4B illustrates the same two-dimensional scene 405 as illustrated in FIG. 4A. However, in FIG. 4B the tree construction algorithm has partitioned BV₁ into two smaller bounding volumes BV₂ and BV₃. The partitioning of BV₁, was accomplished, by drawing a splitting plane SP₁ 415 along the x-axis at point x₁. This partitioning of BV₁ is also reflected in the kd-Tree as the two nodes 455 and 460, corresponding to BV₂ and BV₃ respectively, under the internal or parent node BV₁ 450. The internal node representing BV₁ may now store information such as, but not limited to, pointers to the two nodes beneath BV₁ (e.g., BV₂ and BV₃), along which axis the splitting plane was drawn (e.g., x-axis), and where along the axis the splitting plane was drawn (e.g., at point x₁).

The kd-Tree construction algorithm may continue to partition bounding volume BV₃ because it contains more than the predetermined threshold of primitives (e.g., more than two primitives). However, the kd-Tree construction algorithm may not continue to partition bounding volume BV₂, because bounding volume BV₂ contains less than or equal to the number of primitives (e.g., only two primitives 410_{A}). Nodes which are not partitioned or sub-divided any further, such as BV₂, are referred to as leaf nodes.

FIG. 4C illustrates the same two-dimensional scene 405 as illustrated in FIG. 4B. However, in FIG. 4C the kd-Tree construction algorithm has partitioned BV₃ into two smaller bounding volumes BV₄ and BV₅. The kd-construction algorithm has partitioned BV₃ using a partitioning plane along the y-axis at point y₁. Since BV₃ has been partitioned into two sub-nodes it may now be referred to as an internal node. The partitioning of BV₃ is also reflected in the kd-Tree as the two leaf nodes 465 and 470, corresponding to BV₄ and BV₅ respectively. BV₄ and BV₅ are leaf nodes because the volumes they represent are not further divided into smaller bounding volumes. The two leaf nodes, BV₄ and BV₅, are located under the internal node BV₃ which represents the bounding volume which was partitioned in the kd-Tree.

The internal node representing BV₃ may store information such as, but not limited to, pointers to the two leaf nodes (i.e., BV₄ and BV₅), along which axis the splitting plane was drawn (i.e., y-axis), and where along the axis the splitting plane was drawn (i.e., at point y₁).

The kd-Tree construction algorithm may now stop partitioning the bounding volumes because all bounding volumes located within the scene contain less than or equal to the maximum predetermined number of primitives which may be enclosed within a bounding volume. The leaf nodes may contain pointers to the primitives which are enclosed within the bounding volumes each leaf represents. For example, leaf node BV₂ may contain pointers to primitives 410_{A}, leaf node BV₄ may contain pointers to primitives 410_{B}, and leaf node BV₅ may contain pointers to primitives 410_{c}.

A ray tracing image processing system may use the workload manager 205 to traverse the spatial index (kd-Tree). Traversing the kd-Tree may include selecting a branch to a node on a lower level (sub-node) of the kd-Tree to take or proceed to in order to determine if the ray intersects any primitives contained within the sub-node. A workload manager 205 may use the coordinates and trajectory of an issued ray to traverse or navigate through the kd-Tree. By executing ray-bounding volume intersection tests, the workload manager 205 may determine if the ray intersects a plane of the bounding volumes represented by nodes within the kd-Tree structure. If the ray intersects a bounding volume which contains only primitives (i.e., a leaf node), then the workload manager 205 may send the ray and associated information to a vector throughput engine 210 for ray-primitive intersection tests. A ray-primitive intersection test may be executed to determine if the ray intersects the primitives within the bounding volume. This methodology results in fewer ray-primitive intersection tests needed to determine if a ray intersects an object within the scene, in comparison to running ray-primitive intersection tests for a ray against each primitive contained within the scene.

The resulting kd-Tree structure, or other spatial index structure, may be stored in a processor cache 230. The kd-Tree and the size of corresponding data which comprises the kd-Tree may be optimized for storage in a processor cache 230. The storage of the kd-Tree in a processor cache 230 may allow a workload manager 205 to traverse the kd-Tree with a ray that has been issued by the image processing system without having to retrieve the kd-Tree from memory every time a ray is issued by the image processing system.

### Physics Engine

A physics engine is an application which may simulate real world physical phenomena as applied to objects within a three-dimensional scene. A physics engine may be used to simulate and predict the effects of physical phenomena on a frame to frame basis. For example, the physics engine may perform position updates for an object if the object is moving, and may perform collision detection tests to determine if an object collides with any other objects within the three-dimensional scene.

An image processing system may be used in conjunction with a physics engine to render the simulated physical interactions and objects within a three-dimensional scene to a two-dimensional screen. For example, a video game engine may use both a physics engine and an image processing system to simulate object movements or interactions within a three-dimensional scene and to display the objects and the environment on a monitor.

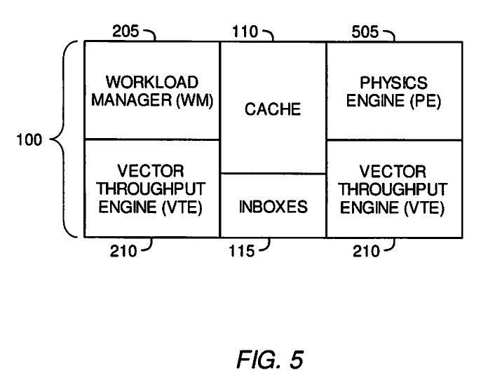

According to one embodiment of the invention, a physics engine may use multiple threads on a multiple core processing element to perform physics related calculations. For example, FIG. 5 illustrates a multiple core processing element 100 wherein the threads of one of the cores are allocated to a physics engine 505. Other cores within the multiple-core processing element may perform image processing related tasks, according to embodiments of the invention. For example, one core within the multiple-core processing element 100 may be allocated to a workload manager 205 and other cores within the multiple-core processing element 100 may be allocated to vector throughput engines 210, according to one embodiment of the invention.

The multiple-core processing element 100 may have a memory cache 110 shared between all of the cores located on the multiple-core processing element 100. Furthermore, each core may have its own cache (e.g., an L1 cache). The multiple-core processing element 100 may also contain inboxes 115. The inboxes 115 may be memory mapped address space used by the cores as a communications network.

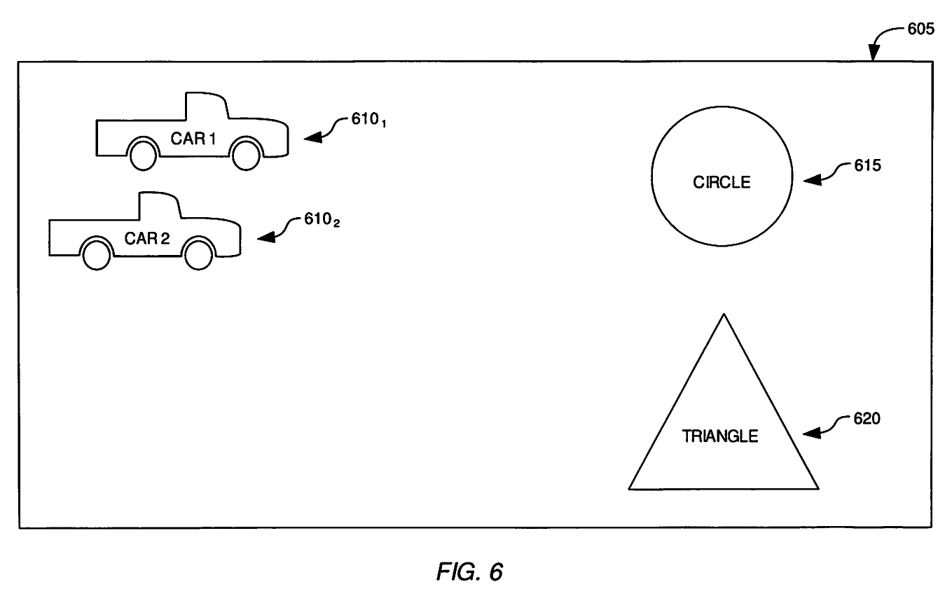

FIG. 6 illustrates an exemplary three-dimensional scene 605. The three-dimensional scene 605 contains several objects including a first car object 610₁, a second car object 610₂, a circle object 615, and a triangle object 620. A physics engine may simulate real world physical phenomena as applied to the objects (i.e., 610₁, 610₂, 615, and 620) within the three-dimensional scene 605 illustrated in FIG. 6.

One structure a physics engine may use to keep track of objects in a three-dimensional scene is a scene graph or a scene index. On a frame to frame basis, the physics engine 505 may use a scene graph to store and access information which defines the objects located within the three-dimensional scene. The scene graph may use a hierarchical structure (e.g., a tree) to index or order the objects.

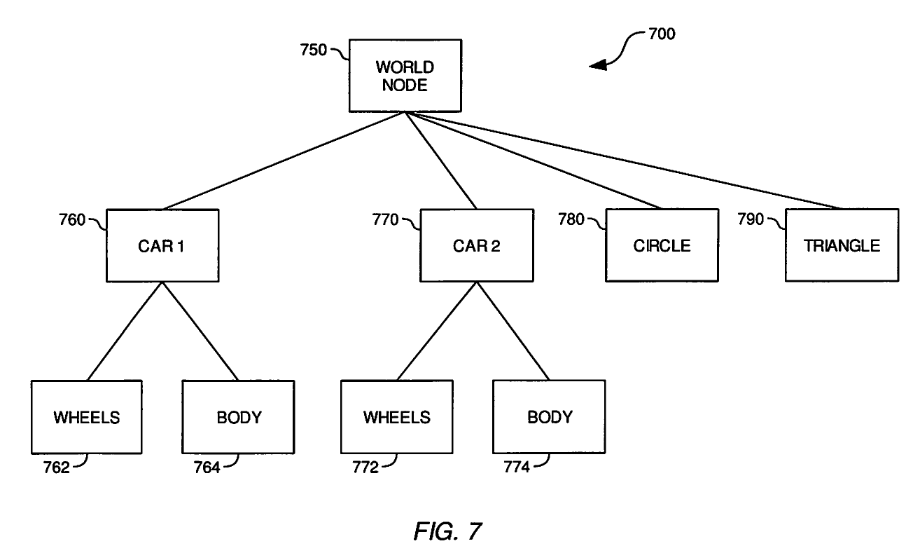

For example, FIG. 7 illustrates an exemplary scene graph 700, according to one embodiment of the invention. As illustrated, the scene graph 700 may contain a world node 750 which represents the entire three-dimensional scene 605. The world node 750 may branch to nodes which represent objects within the three-dimensional scene. For example, the world node 750 may branch to four object nodes. Each of the four object nodes in the scene graph 700 may correspond to one of the four objects within the three-dimensional scene 605 of FIG. 6 (i.e., a node 760 corresponding to the first car object 610₁, a node 770 corresponding to the second car object 610₂, a node 780 corresponding to the circle object 615, and a node 790 corresponding to the triangle object 620).

The object nodes may branch to other nodes on a lower level of the scene graph 700. The branched to nodes may represent objects which make up part of the larger object or may be nodes which define the object (position, color, mass, etc.). For example, the node 760 representing the first car object branches to a node 762 representing a wheels object and to a node 764 representing a body object. Thus, the scene graph is a hierarchical acceleration data structure based on objects located within a three-dimensional scene.

The scene graph may be stored, for example, in a memory cache (e.g., cache 110) of a processing element to enable the physics engine 505 fast access to the information contained within the scene graph 700. Because a scene graph 700 is an object oriented structure and a physics engine performs calculations on an object by object basis, a scene graph is an efficient structure to use with a physics engine.

In contrast to a physics engine using a scene graph, an image processing system may use a spatial index (e.g., a kd-tree) to render a two-dimensional image from a three-dimensional scene. As described previously with respect to FIG. 4, a spatial index partitions a three-dimensional scene based on a spatial or bounding volume hierarchy. Because a scene graph is a spatial based structure and a ray tracing image processing system performs calculations based on where a ray traverses through a three-dimensional scene, a spatial index is an efficient structure to use with a ray tracing image processing system.

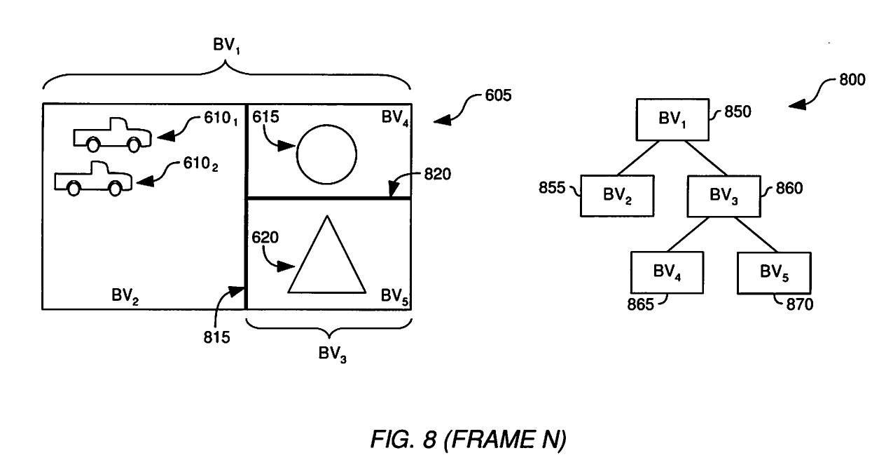

FIG. 8 illustrates a spatial index 800 which may be used by an image processing system to render a two-dimensional image from the three-dimensional scene 605. The three-dimensional scene 605 illustrated in FIG. 7 may be the same three-dimensional scene 605 to which the scene graph 700 corresponds.

The spatial index 800 may contain a world node 850 which defines bounding volume 1 (BV₁) which encompasses the entire volume of the three-dimensional scene 605. BV₁ may be partitioned into two smaller bounding volumes BV₂ and BV₃ through the use of a splitting plane 815. The partitioning of BV₁ is reflected in the kd-Tree as the two nodes 855 and 860, corresponding to BV₂ and BV₃ respectively, under the internal or parent node BV₁ 850. The internal node 850 representing BV₁ may now store information such as, but not limited to, pointers to the two nodes beneath BV₁ (e.g., BV₂ and BV₃), along which axis the splitting plane 815 was drawn (e.g., x-axis), and where along the axis the splitting plane 815 was drawn.

Furthermore, BV₃ may be partitioned into two smaller bounding volumes BV₄ and BV₅. Two leaf nodes 865 and 870 in the spatial index may correspond to the bounding volumes BV₄ and BV₅, respectively.

The leaf nodes (i.e., 855, 865, and 870) of the spatial index 800 may include information which defines the corresponding bounding volumes within the three-dimensional scene (i.e., BV₂, BV₄ and BV₅) and may contain pointers to primitives located within the corresponding bounding volumes.

On a frame to frame basis, objects within the three-dimensional scene may move or change shape. In response to changes in position or shape of objects, the spatial index may need to be updated such that the spatial index accurately reflects the location of objects or primitives within the three-dimensional scene. Similarly, a scene graph used by the physics engine 505 may also need to be updated to accurately reflect the new position or shape of objects within the three-dimensional scene. Thus, in response to objects moving or changing shape, two data structures may need to be updated on a frame to frame basis.

The image processing system may store the spatial index 800, for example, in the memory cache (e.g., cache 110). As previously described, a scene graph may also be stored in the memory cache 110 of the multiple core processing element 100. However, in some circumstances the memory cache 110 may not have enough storage space available to efficiently store both the scene graph 700 and the spatial index 800.

### Intergrated Acceleration Data Structure for Physics and Ray Tracing Image Processing

According to embodiments of the invention, an integrated acceleration data structure may be used by both the physics engine 505 and the image processing system in order to perform both physics calculations and to perform ray tracing respectively. A single integrated acceleration data structure may perform the functions of a spatial index and may simultaneously perform the functions of a scene graph. By using a single integrated acceleration data structure rather than using two data structures, the amount of space required to store information sufficient for both the physics engine 505 and the image processing system to perform their respective tasks may be reduced. Furthermore, in contrast to the need to update two data structures in response to movements of objects within the three-dimensional scene, the image processing system may only need to update a single data structure (i.e., the integrated acceleration data structure). The processing time gained by only updating a single data structure may reduce the time necessary to perform physics engine tasks and image processing tasks, thus increasing overall system performance.

According to one embodiment of the invention, an integrated spatial index may be formed by initially partitioning a three-dimensional scene into bounding volumes that encompass objects within the three-dimensional scene. Accordingly, the initial or top portions of the integrated acceleration data structure are formed based on a spatial or bounding volume hierarchy. Once a bounding volume encompasses an object within the three-dimensional scene, an object oriented hierarchy may be used to represent the object within the bounding volume. Thus, the lower portions of the integrated acceleration data structure are formed based on an object oriented hierarchy. Consequently, the initial or top portions of the integrated acceleration data structure may resemble a spatial index 800 (eg., a kd-tree) and the lower portions of the integrated acceleration data structure may resemble a scene graph 700.

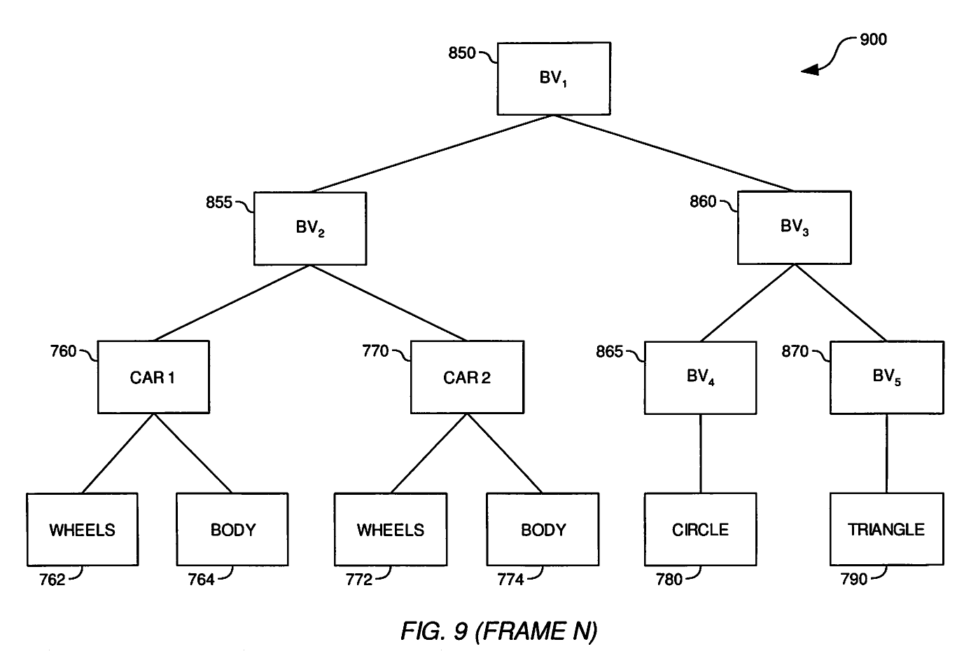

FIG. 9 illustrates an integrated acceleration data structure 900, according to one embodiment of the invention. The exemplary integrated acceleration data structure 900 corresponds to the three-dimensional scene 605 illustrated in FIG. 6.

The integrated acceleration data structure 900 illustrated in FIG. 9 has an initial structure defined by the spatial index 800 which was described with reference to FIG. 8, having a world node and smaller bounding volumes.

According to embodiments of the invention, in order to form an integrated acceleration data structure 900, the nodes which define bounding volumes within the three-dimensional scene may branch to (I.e., contain information which points to) nodes which define objects located within bounding volumes. Thus, in contrast to a spatial index where the final spatially oriented nodes (i.e., the leaf nodes) only point to primitives, the final spatially oriented nodes in an integrated acceleration data structure 900 may branch to object nodes which define objects.

For example, as illustrated in FIG. 9, node 855 corresponding to BV₂ may branch to object nodes 760 and 770 (representing the first car object 610₁ and the second car object 610₂) from the scene graph 700. The object nodes 760 and 770 are branched to from the node 855 corresponding to BV₂ because the first car object 610₁ and the second car object 610₂ are both located within bounding volume BV₂ as illustrated in FIG. 8.

Similar to the scene graph 700, the nodes branched to from each object node in the integrated acceleration data structure 900 may continue to define properties of the objects or portions of the object which collectively construct the object. For example, each car object node branches to a wheel object node (e.g., 762 or 772) and a body object node (e.g., 764 or 774), which further define each car object.

Also illustrated in the integrated acceleration data structure 900 are nodes corresponding to the remaining objects in the three-dimensional scene 605. For example, the circle object node 780 is branched to from the node 865 defining the bounding volume BV₄. The circle object node 780 may be branched to from the node 865 defining bounding volume BV₄, because the circle object 615 is located within bounding volume BV₄. Furthermore, the triangle object node 790 is branched to from the node 870 defining the bounding volume BV₅. The triangle object node 790 may be branched to from the node 865 defining bounding volume BV₅, because the triangle object 620 is located within bounding volume BV₅.

In order for a physics engine 505 or an image processing system to determine if a node corresponds to an object or to a bounding volume, each node within the integrated acceleration data structure may contain an object node flag or bit. The object node bit may be a single bit located within the memory space which defines a node within the integrated acceleration data structure 900. According to one embodiment of the invention, if a node within the spatial index is an object node, the object node bit may be asserted. Furthermore, if a node within the spatial index is not an object node, the object node bit may not be asserted. Thus, a physics engine 505 performing physics calculations or the image processing system performing ray tracing may be able to quickly determine if the node is an object node or a node defining a bounding volume by determining if the object node bit is asserted.

### Intergrated Accelaration Data Structure Usage

According to embodiments of the invention, an image processing system may perform ray tracing with an integrated acceleration data structure. As described with regards to FIG. 4, when using a spatial index (e.g., a kd-tree) the image processing system may use a workload manager 205 to issue rays into the three-dimensional scene and to trace the rays (based on the trajectory of the ray) through the three-dimensional scene. The workload manager 205 may trace rays through the three-dimensional scene using the spatial index by performing ray-Abounding volume intersection tests against the bounding volumes defined by the nodes in the spatial index. The workload manager 205 may take branches to nodes based on which bounding volumes are intersected by the ray. When the workload manager 205 traverses to a certain point within the spatial index (e.g., a leaf node defining a bounding volume), the workload manager 205 may send the ray to a vector throughput engine 210 to determine if the ray intersects any primitives (e.g., contained within the bounding volume defined by the leaf node). If the ray intersects a primitive, the vector throughput engine 210 may consequently determine the color contribution to the two-dimensional image based on an intersected primitive. If not, the workload manager 205 may traverse the kd-tree again to determine if the ray intersects any other primitives located within the three-dimensional scene.

The image processing system may use an integrated acceleration data structure 900 to perform ray tracing, in a manner similar to using a spatial index. The image processing system may issue rays into the three-dimensional scene and trace rays through the three-dimensional scene using the integrated acceleration data structure 900 by performing ray-bounding volume intersection tests against the bounding volumes defined by the spatially oriented nodes in the spatial index. The workload manager 205 may take branches to nodes based on which bounding volumes are intersected by the ray. When the workload manager 205 traverses to a certain point within the integrated acceleration data structure (e.g., an object node), the workload manager 205 may send the ray to a vector throughput engine 210 to determine if the ray intersects any primitives. However, according to other embodiments of the invention, the workload manager 205 may determine if the ray intersects any primitives.

Furthermore, the physics engine 505 may perform physics related tasks using the integrated acceleration data structure. When using a scene graph the physics engine may determine the effect of physical phenomena on objects within the three-dimensional scene 605 on an object-by-object basis. The physics engine 505 may perform the same physics calculations with an integrated acceleration structure on an object-by-object basis by searching for object nodes within the integrated acceleration data structure 900. The physics engine 505 may determine if a node is an object node by checking the object node bit in the information which defines the node. Once a node is found within the integrated acceleration data structure that has its object node bit asserted, the physics engine may perform physics calculations on the object.

Thus, by forming a data structure which uses both a spatial (or bounding volume) oriented hierarchy and an object oriented hierarchy, a single data structure may be formed which may be used by both the image processing system and the physics engine 505.

Although in the preceding example the integrated acceleration data structure 900 has been described wherein each entire object may be contained within a single bounding volume, in some circumstances portions of objects may be located within two separate bounding volumes. That is, objects within the three-dimensional scene may be divided by a splitting plane which creates a boundary between bounding volumes. Consequently, portions of an object may be located within separate bounding volumes created by the splitting plane.

In this scenario, according to one embodiment of the invention, the information defining an object node may contain a bit location which indicates that information which defines the entire object is located within a plurality of object nodes within the integrated acceleration data structure. The bit within the information defining an object node may be asserted to indicate that information which defines the object may be located within a plurality of object nodes of the integrated acceleration data structure, and de-asserted to indicate that the information which defines the object is located entirely within the current object node.

Furthermore, if an object node which contained only a portion of an object was created when constructing the integrated acceleration data structure, a pointer to another object node (or nodes) which contain the remaining information which defines the object may be stored in each object node (which contains a portion of the object, according to one embodiment of the invention. Thus, the physics engine may quickly find the other object node(s) within the integrated acceleration data structure. By using a bit within the information defining an object node to indicate whether or not the object is defined within a plurality of object nodes, the likelihood may be reduced that a physics engine 505 performing position updates or collision detection tests fails to perform tests against all of the portions of an object located within the three-dimensional scene.

### Updating an Integrated Acceleration Data Structure in Response to Object Movements

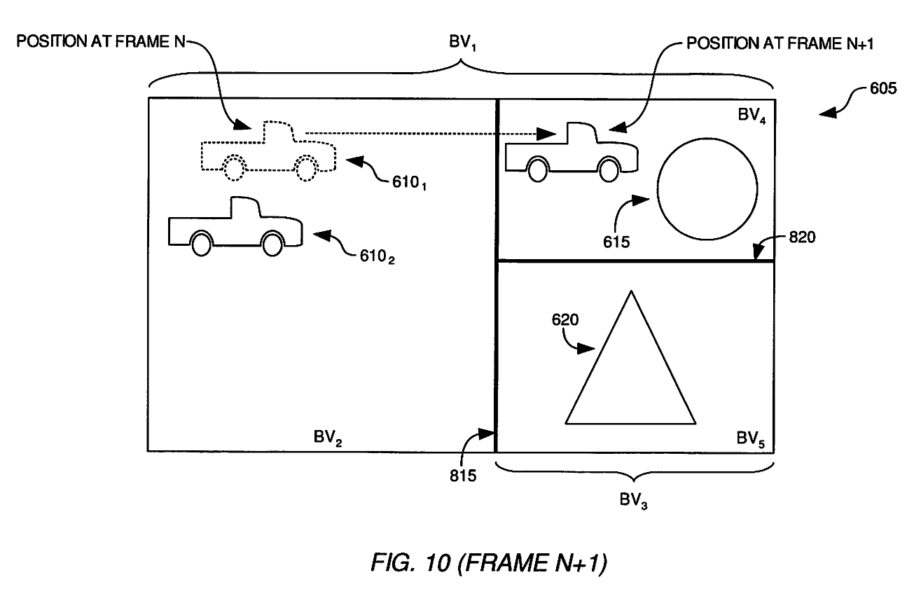

According to embodiments of the invention, an integrated acceleration data structure 900 may be used to maintain a record of movements or changes to objects located within the three-dimensional scene. For example, in contrast to the three-dimensional scene 605 illustrated in FIG. 6, FIG. 10 illustrates a three-dimensional scene 605B where the first car object 610₁ has moved from a first position in the frame N of the three-dimensional scene 605 to a second position in frame N+1 of the three-dimensional scene 605 (as illustrated by the dashed lines in FIG. 10).

In response to the movement of the first car object 610₁, hardware or software components within the image processing system may update the integrated acceleration data structure 900.

According to one embodiment of the invention, the physics engine 505 may update the integrated acceleration data structure 900 to reflect change in position or shape of objects within the three-dimensional scene 605. The physics engine 505 may perform position updates and collision detection tests for all of the objects located within the three-dimensional scene. For example, the object node 760 corresponding to the first car object 610₁ may be updated to reflect the new position of the first car object 610₁. After performing the tests, the physics engine 505 may record the results of the calculations (e.g., the new positions of the objects) in the integrated acceleration data structure 900.

Furthermore, if an object has moved such that the branches to nodes within the integrated acceleration data structure need to be updated, the physics engine 505 may update the branches as well. For example, the movement of the first car object 610₁ from its position illustrated in frame N of the three-dimensional scene 605 (as seen in FIG. 7) to its position illustrated in frame N+1 of the three-dimensional scene (as seen in FIG. 10) may require that the physics engine 505 update the position of the first car object 610₁ in the integrated acceleration data structure 900. Furthermore, as illustrated in FIG. 10 the first car object has moved to such a degree that it is no longer located within the bounding volume BV₂, rather the first car object 610₁ has moved such that it is located within the bounding volume BV₄. Thus, the physics engine 505 may update the integrated acceleration data structure 900 so that the node 865 corresponding to BV₄ branches to the object node 760 corresponding to the first car object 610₁.

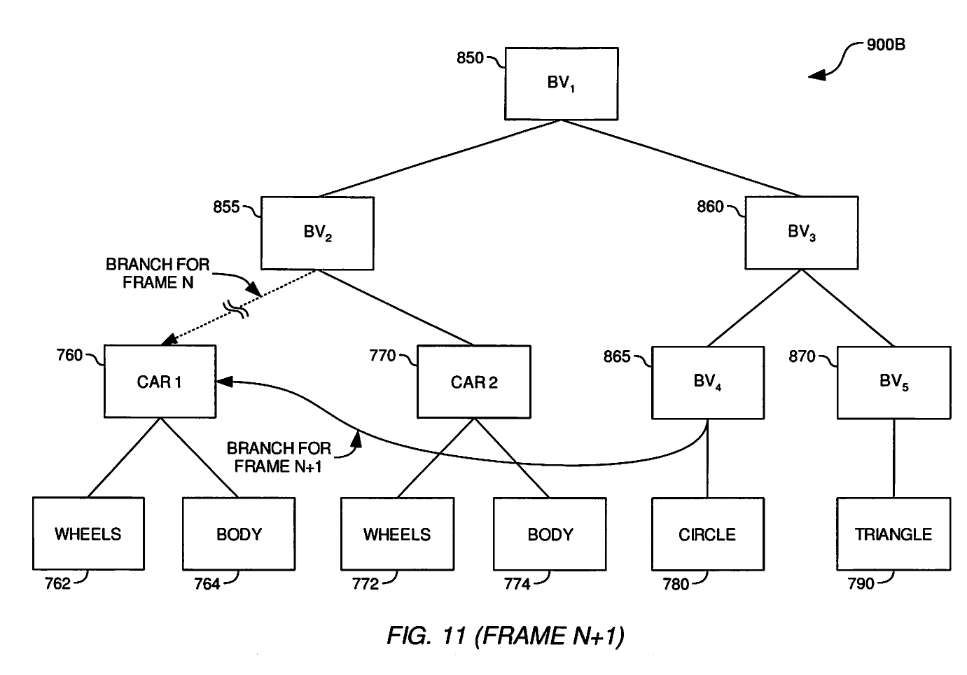

For example, FIG. 11 illustrates an updated integrated acceleration data structure 900B which reflects the new position of the first car object 610₁. The branch from the node 855 corresponding to BV₂ to the object node 760 corresponding to the first car object 610₁ may have been removed or deleted by the physics engine 505 to reflect the movement of the first car object 610₁ out of the bounding volume BV₂. Furthermore, a new branch from the spatial index node 865 corresponding to BV₄ to the object node 760 corresponding to the first car object 610₁ may have been added by the physics engine 505 to reflect the movement of the first car object 610₁ into the bounding volume BV₄. Thus, the new position of the first car object 610₁ in the three-dimensional scene 605 is now reflected in the updated integrated acceleration data structure 900B.

As illustrated in FIG. 11, the remaining nodes and branches in the updated integrated acceleration data structure 900B are the same as in the integrated acceleration data structure 900 because (in this simple example) no other objects moved from frame N to frame N+1. The image processing system may now use the updated integrated acceleration data structure 900B to render a two-dimensional image from the three-dimensional scene 605, and the physics engine 505 may use the updated integrated acceleration data structure 900B to perform physics related calculations.

### Physics Engine Collision Detection

As mentioned above, one function of a physics engine is to perform collision tests. Collision tests may determine, for example, if an object which is moving within the three-dimensional scene collides with any other objects within the three-dimensional scene. If the moving object collides with any other objects, the physics engine may also perform calculations to determine the effects of the collision on the moving object and the objects with which the moving object collided (e.g., new direction, position, and/or shape of the objects). The physics engine may then update a data structure (e.g., the integrated acceleration data structure) with the results of the calculations, and the image processing system may use the updated data structure to render a two-dimensional image of the three-dimensional scene.

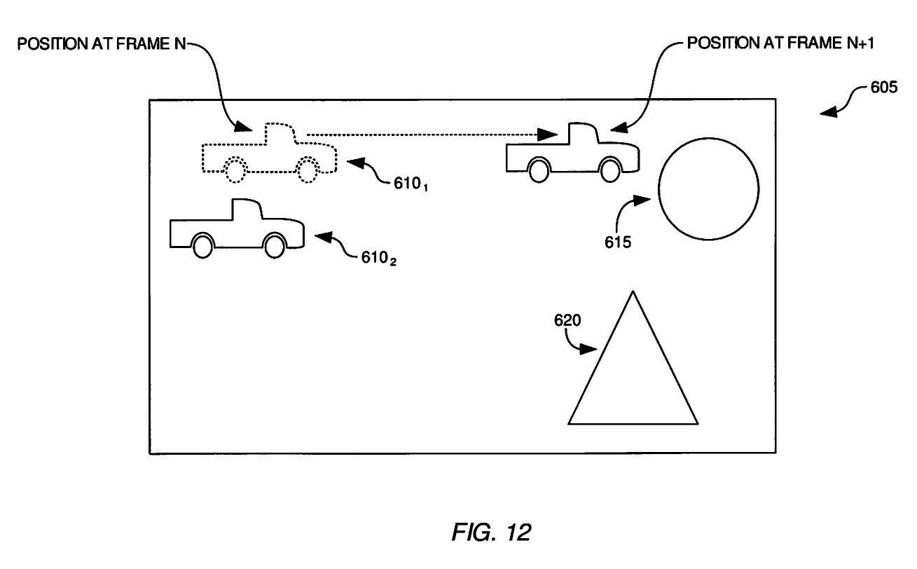

FIG. 12 illustrates an exemplary three-dimensional scene 605 containing several objects including a first car object 610₁, a second car object 610₂, a circle object 615, and a triangle object 620. The first car object 610₁ may moving (at a given velocity) within the three-dimensional scene. Over a period of time (e.g., a single frame) the car object 610₁ may move from a first position (illustrated by the dashed outline of the car object 610₁) to a second position.

In order to provide realistic simulation of physical phenomenon, the physics engine may perform collision tests (collision detection tests) with the first car object 610₁ and each of the other objects within the three-dimensional scene to determine if the first car object 610₁ collides with any other objects within the three-dimensional scene over the time period (e.g., for a single frame).

For example, the physics engine may perform collision tests with the first car object 610₁ and the second car object 610₂, the first car object 610₁ and the circle object 615, and the first car object 610₁ and the triangle object 620. Although this technique may determine which objects collide with the moving object, the technique may execute collision tests with objects which are unlikely to collide with the moving object. For example, this technique may execute a collision test with the first car object 6101 and the triangle object 620 which are relatively far away from one another and are unlikely to collide. Therefore, this technique may be inefficient in determining collisions between the moving object and other objects.

However, a physics engine may reduce the number of collision tests which may be performed by only performing collision tests with objects that are likely to collide with the moving object. The physics engine may determine which objects are likely to collide with the moving object by creating a bounding volume which encloses the path of the moving object from the first position to the second position (hereinafter a “velocity box”) and performing intersection tests with the velocity box and every other object within the three-dimensional scene. The objects which intersect the velocity box may be more likely to collide with the moving object. Therefore, the physics engine may use the objects which intersect with the velocity box to perform collision tests with the moving object to determine which objects collide with the moving object. Consequently, the number of collision tests may be reduced by the number objects which do not intersect the velocity box.

In contrast to an object-to-object collision test, a test for an intersection of the velocity box and an object within the three-dimensional scene may take less time and processing power. For example, a collision test may require many more variables such as the velocity of the moving object, direction in which the moving object is traveling, the coordinates of both objects (i.e., the moving object and the object being tested), and the dimensions of both objects. Whereas, an intersection test may simply require the dimensions and coordinates of the velocity box and the dimensions and coordinates of the other object being tested for an intersection with the velocity box. Consequently, it may be more efficient to execute intersection tests using a velocity box than to execute collision tests with every object within the three-dimensional scene.

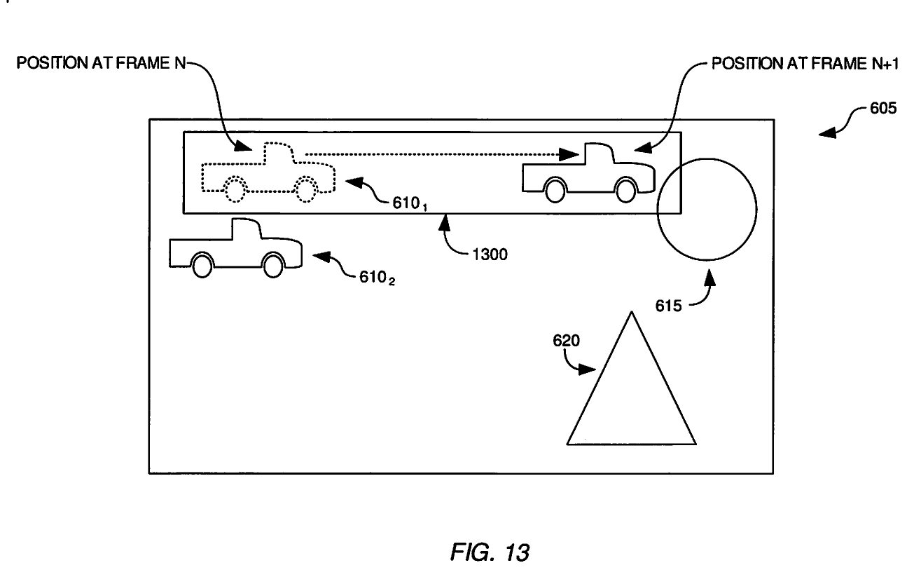

FIG. 13 illustrates an exemplary velocity box 1300 which encloses the moving first car object 610₁. As illustrated the velocity box 1300 may be a simple rectangular box the dimensions of which are based on the dimensions of the moving object and the distance the moving object may move over the period of time under evaluation. The evaluation time period may be the period of a frame, or may be shorter and iterated many times for a single frame to prevent adverse effects (e.g. tunneling).

The velocity box may also be a more complex shape (e.g., a cylinder) which better reflects the path of the object from its initial position to its final position. A more complex shape may further reduce the number of objects which may collide with the velocity box. The complexity of the shape of the velocity box created by the physics engine may ultimately depend on a balance between the processing time necessary for the physics engine to create a more complex velocity box and the number of collision tests which may be reduced by creating a more complex velocity box.

After creating the velocity box 1300 the physics engine may perform intersection tests with the velocity box 1300 and objects within the three-dimensional scene 605. For example, intersection tests may be performed with the velocity box 1300 and the second car object 610₂, the velocity box 1300 and the circle object 615, and the velocity box 1300 and the triangle object 620. As a result of performing these intersection tests, the physics engine may determine that the velocity box 1300 intersects the circle object 615 (the intersection of the velocity box 1300 and the circle object 615 is illustrated in FIG. 13). Thus, a collision between the first car object 610₁ and the circle object 615 may be likely. Consequently, the physics engine may only need to perform a single collision detection test (i.e., with the first car object 610₁ and the circle object 615).

By determining which objects are likely to intersect the moving first car object 610₁ the physics engine was able to reduce the number of collision tests from three tests to one test. Although testing objects within the three-dimensional scene for intersections with the velocity box may add to the total number tests which may need to be performed from three tests to four tests (i.e., one collision test plus three intersection tests), the increase in tests will be less computationally expensive and consume less time than executing three collision tests. Therefore, the overall result may be a reduction in the time necessary to determine if the moving object collides with any other objects.

### Box Casting Using an Integrated Acceleration Data Structure

Although intersection tests with a velocity box may reduce the number of collision tests which may need to be performed by the physics engine, the physics engine may still need to perform intersection tests with the velocity box and each object within the three-dimensional scene in order to determine which objects are likely to collide with the moving object. In a complicated three-dimensional scene containing many objects, this may result in a large number of intersection tests which may need to be performed to determine which collisions with the moving object are likely.

However, according to one embodiment of the invention, a physics engine may use the spatial information stored in the integrated acceleration data structure to determine which objects within the three-dimensional scene are within the same area as the velocity box and thus are likely to intersect the velocity box. Similar to how an image processing system may cast a ray into a three-dimensional scene and traverse the integrated acceleration data structure to determine objects which are intersected by the ray, according to embodiments of the invention, the physics engine may cast a velocity box into the three-dimensional scene and traverse the velocity box (based on the dimensions and location of the velocity box) through the integrated acceleration data structure to determine which bounding volumes the velocity box intersects (Le., a portion of the velocity box exists within a bounding volume). The physics engine may then perform intersection tests with objects within the intersected bounding volumes (i.e., objects which are in the same area as the velocity box) which are more likely to intersect the velocity box.

Conversely, objects which are in bounding volumes which are not intersected by the velocity box may be excluded by the physics engine when performing intersection tests, because they are not in the same area as the velocity box and thus will not intersect the velocity box. Therefore, in contrast to a physics engine performing intersection tests with the velocity box and every other object within the three-dimensional scene, the physics engine may perform intersection tests with objects which are in the same bounding volumes and thus the same area as the velocity box. Consequently, the physics engine may reduce the number of intersection tests which may need to be performed.

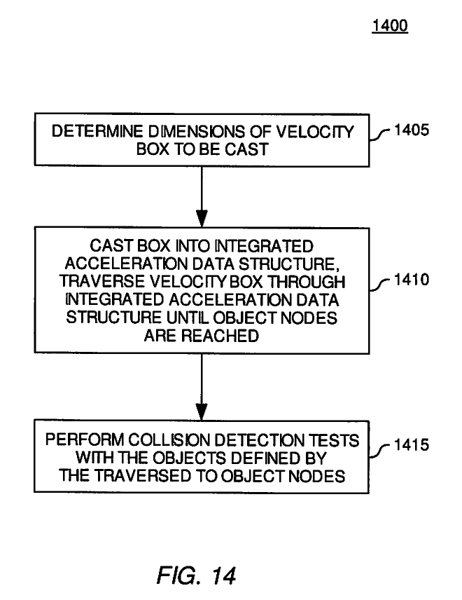

FIG. 14 illustrates a method 1400 of casting a velocity box into an integrated acceleration data structure, according to one embodiment of the invention. The method 1400 may begin, for example, when a physics engine determines that an object will move within the three-dimensional scene. Initially, at step 1405, the physics engine may determine the dimensions of the velocity box to be cast into the three-dimensional scene.

As mentioned above, the dimensions of the velocity box may be determined based on the dimensions of the moving object and the amount of distance the moving object may travel over the time period under evaluation (e.g., a single frame). The dimensions of the velocity box should be such that it encompasses the moving object over the entire path of movement being evaluated. For example, the velocity box 1300 in FIG. 13 encompasses the first car object 610, in both its first position and its second position (i.e., the amount of distance the first car object traveled). According to embodiments of the invention, the velocity box may be created such that is an axis-aligned velocity box (i.e., sides which are parallel or perpendicular to the axes which are used to create the spatial index) or may be created such that it is not axis-aligned (i.e., sides of the velocity box not parallel or perpendicular to the axes which are used to create the spatial index). However, an axis-aligned velocity box may be easier to traverse through the integrated acceleration data structure.

Next, at step 1410, the velocity box may be cast into the integrated acceleration data structure and traversed through the integrated acceleration data structure. This may entail testing bounding volumes defined by the nodes in the integrated acceleration data structure to determine if a portion of (or the entire) velocity box intersects or is within a bounding volume defined by a node. The physics engine may begin traversing the velocity box through the integrated acceleration data structure at the world node.

If a portion of the velocity box is located within the bounding volume defined by the world node, the physics engine may take the branches to the nodes beneath the world node. The nodes beneath the world nodes may define bounding volumes which are created by a splitting plane through the bounding volume defined by the world node (e.g., an axis-aligned splitting plane). The physics engine may determine if the velocity box, or a portion of the velocity box, is within the bounding volumes defined by the nodes below the world node. If so, the physics engine may take the branches from the nodes below the world node to nodes beneath or on a lower level of the integrated acceleration data structure. The bounding volume intersection tests and taking branches to nodes beneath nodes which defines bounding volumes intersected by the velocity box may continue until an object node is reached or a node is reached which does not contain a portion of the velocity box. The objects which are defined by the object nodes which are traversed to may be placed into a set of objects to be used later in intersection tests with the velocity box.

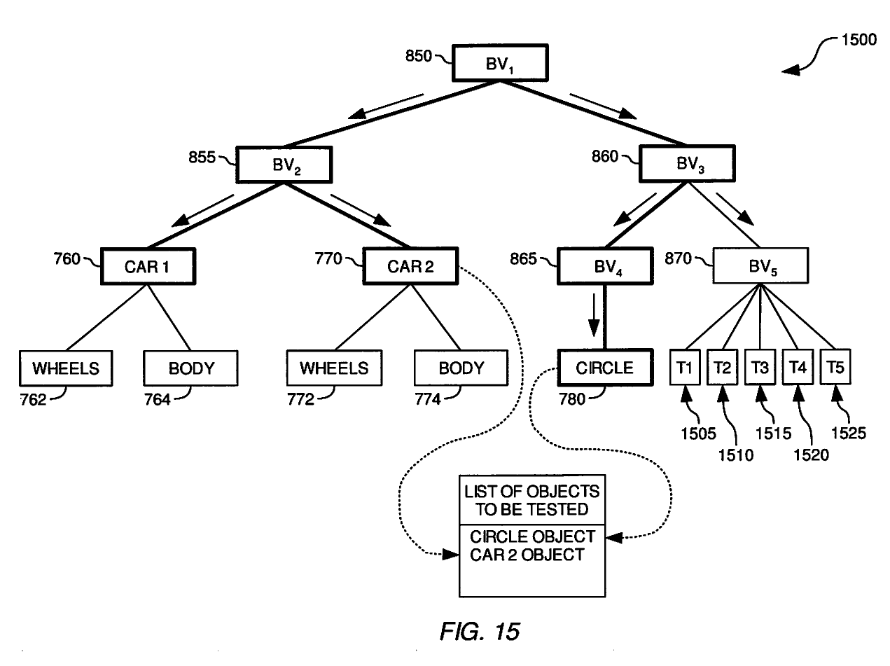

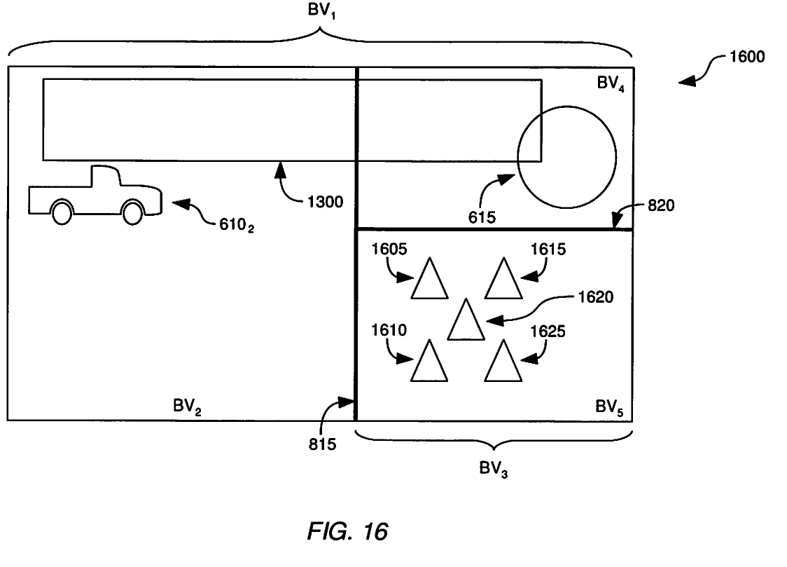

For example, FIG. 15 illustrates an integrated acceleration data structure 1500 which corresponds to a three-dimensional scene 1600 illustrated in FIG. 16. The integrated acceleration data structure contains nodes which define bounding volumes (e.g., BV₁-BV₅) within the three-dimensional scene 1600. The integrated acceleration data structure 1500 is similar to the earlier described integrated acceleration data structure 900 of FIG. 9 with the exception of several object nodes (ie., object node 1505, object node 1510, object node 1515, and object node 1520) which correspond to objects located within a bounding volume (i.e., BV₅) of the three-dimensional scene 1600.

The physics engine may begin traversing the velocity box 1300 (illustrated in FIG. 1600) through the integrated acceleration data structure 1500 by determining if the velocity box 1300 is within or intersects the bounding volume defined by the world node 850 (i.e., BV₁). As can be seen in FIG. 16, the velocity box 1300 is within the bounding volume defined by the world node 850 (i.e., BV₁), and therefore the results of the physics engine's determination will indicate the intersection. An intersection of the velocity box 1300 with a bounding volume defined by nodes (e.g., world node 850) in the integrated acceleration data structure 1500 is illustrated in FIG. 15 by the darkened outline of the nodes (e.g., the darkened outline of the world node 850).

Next, the physics engine may continue to traverse the integrated acceleration data structure 1500 by taking the branches from the world node 850 to the nodes beneath the world node 850 (i.e., node 855 and node 860). The physics engine may then perform tests to determine if the velocity box 1300 intersects or is within the bounding volumes defined by the nodes beneath the world node 850 (i.e., BV₂ and BV₃). The physics engine may determine from these tests that the velocity box 1300 is within or intersects the bounding volumes defined by the nodes beneath the world node 850 (i.e., the velocity box 1300 intersects both BV₂ and BV₃). The physics engine may then continue traversing the integrated acceleration data structure 1500 by taking the branches from the intersected nodes to the nodes beneath the intersected nodes.

As illustrated in FIG. 15, the physics engine may take a branch from node 855 (defining bounding volume BV₂) to the first car object node 760 and another branch from node 855 to the second car object node 770. Consequently, the second car object 610₂ is in the same areas as the velocity box 1300, and is likely to intersect the velocity box 1300. Therefore, the physics engine may add the second car object 610₂ to a list of objects which may be used later in intersection tests to determine which objects intersect the velocity box 1300. While the first car object 610₁ may be within the same area as the velocity box 1300, the first car object 610₁ may be excluded from the intersection tests by the physics engine because the first car object is the moving object.

The physics engine may also take the branches from node 860 (defining bounding volume BV₃) to nodes beneath node 860 (i.e., node 865 and node 870). Both node 865 and node 870 define bounding volumes (i.e., BV₄ and BV₅), not object nodes. Therefore, the physics engine may perform tests to determine if the velocity box is within or intersects the bounding volumes defined by node 865 and node 870. As can be see in FIG. 16, part of the velocity box 1300 is within BV₄ but no portion of velocity box 1300 is within BV₅. Therefore, the results of the intersection tests may indicate that a portion of the velocity box is within the bounding volume defined by node 865 (i.e., BV₄), but that no portion of the velocity box is within the bounding volume defined by node 870 (ie., BV₅). The intersection with BV₄ and not BV₅ is illustrated in FIG. 15 by the darkened outline of node 865 which corresponds to BV₄, but no darkened outline of node 870 corresponding to BV₅. Consequently, the physics engine may take branches from node 865 but not from node 870. As illustrated in FIG. 15, the branch from node 865 leads to the object node 780 which corresponds to the circle object 615 contained within bounding volume BV₄. Consequently, the circle object 615 may be in the same area of the velocity box 1300 and thus is likely to intersect the velocity box 1300. Therefore, the physics engine may add the circle object 615 to a list of objects which may be later used intersection tests to determine which objects intersect with the velocity box 1300. However, the physics engine may not use the objects located within BV₅ (i.e., triangle objects 1605-1625) and branched to from node 870 because those objects are not in the same area as the velocity box.

After the physics engine has finished traversing the velocity box through the integrated acceleration data structure, the physics engine may proceed to step 1415 of method 1400 to perform intersection tests with the list of objects which are defined by the traversed to objects nodes in the integrated acceleration data structure. The results of these intersection tests indicate which objects intersect with the velocity box and therefore are likely to collide with the moving object. The physics engine may use those objects when performing collision tests with the moving object. The results of the collision tests may indicate which objects actually collide with the moving object. Consequently, the physics engine may calculate new positions of the moving object and the objects which intersect the moving object and store the new positions, for example, within the integrated acceleration data structure. The image processing system may use the updated integrated acceleration data structure to render a two-dimensional image using the new positions of the objects in the three-dimensional scene.

For example, as was determined by traversing velocity box 1300 through the integrated acceleration data structure 1500, the physics engine may perform intersection tests with the second car object 610₂ and the circle object 615 which were contained within the traversed to bounding volumes (ie., BV₂ and BV₄, respectively). The intersection tests may determine that only the circle object 615 intersects the velocity box 1300. Consequently, the physics engine may perform a collision test with the moving object (i.e., the first car object 6101) and the circle object 615. In contrast to a physics engine which does not cast the velocity box into the three-dimensional scene and traverse the velocity box through the three-dimensional scene, the physics engine may reduce the number of velocity box/object intersection tests by five. The reduction in five intersection tests is due to the physics engine not performing intersection tests with the five triangle objects (i.e., triangle objects 1605-1625) which are contained within the bounding volume which was not intersected by the velocity box (i.e., BV₅). In comparison a physics engine which does not traverse the velocity box through an integrated acceleration data structure, rather merely performs intersection tests with the velocity box and every other object within the three-dimensional scene will execute intersection tests with the velocity box and the triangle objects (i.e., triangle objects 1605-1625).

Although, in the present example, the reduction in calculations is relatively small, in a three-dimensional scene containing many objects, casting a velocity box into the scene and traversing the velocity box through the integrated acceleration data structure to determine which objects may be used in collision tests may result in a substantial reduction in calculations. Consequently, the processing time required to perform physics simulation may be substantially reduced.

In addition to reducing the number of objects which may need to be tested against to determine if the moving object collides with other objects, box casting may be used to parallelize physics calculations in a multi-processor environment. For example, a physics engine may use box casting to parallelize collision detection in the multiple-core processing element 100 or in the network of multiple-core processing elements 200.

According to one embodiment of the invention, a physics engine may parallelize collision detection by box casting to determine which objects a moving object is likely to collide, and then using separate processing elements to determine if the moving object collides with any of the objects which are likely to collide with the moving object. The separate processing elements may perform intersection tests and collision detection tests to determine if the moving object collides with any of the objects which are likely to collide with the moving object.

For example, a physics engine may use box casting to determine that two objects are likely to intersect a moving object. The physics engine may then use a thread of a first processing element (e.g., a BTE 105) to execute intersection tests and collision tests to determine if the moving object collides with a first of the two objects, and a thread of a second processing element (e.g., a BTE 105) to execute intersection tests and collision tests to determine if the moving object collides with a second of the two objects. Thus, the physics engine may parallelize collision detection by using box casting and two separate processing elements.

### Artificial Intelligence System

An artificial intelligence system (AIS) may be used in combination with a game engine or game system to simulate aspects of human intelligence. For example, an AIS may be used to control the behavior of various characters in a video game such that the characters make human-like decisions or exhibit human-like behavior. An AIS may be used with the physics engine and the image processing systems described above, for example, in a game system in order to provide a realistic, animated, and interactive environment.

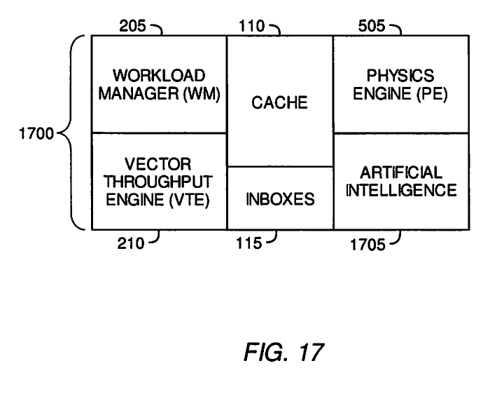

An AIS may be constructed of various software and hardware components in a computer or game system. According to one embodiment of the invention, an AIS may use multiple threads on a multiple core processing element to perform artificial intelligence related calculations. For example, FIG. 17 illustrates a multiple core processing element 1700 wherein the threads of one of the processing elements (cores) are allocated to an AIS 1705. Other cores within the multiple-core processing element may perform image processing related tasks and physics related tasks, according to embodiments of the invention. For example, one core within the multiple-core processing element 1700 may be allocated to a workload manager 205, another allocated to vector throughput engine 210, and another core allocated to a physics engine 505 according to one embodiment of the invention.

The multiple-core processing element 1700 may have a memory cache 110 shared between all of the cores located on the multiple-core processing element 100. Furthermore, each core may have its own cache (e.g., an L1 cache). The multiple-core processing element 100 may also contain inboxes 115. The inboxes 115 may be memory mapped address space used by the cores as a communications network.

### Using Ray Tracing to Enhance Artificial Intelligence Character Behavior

As described above, an AIS may be used in a game system, for example, to simulate human-like behaviors for characters within a three-dimensional scene. According to embodiments of the invention, ray tracing may be used to enhance the artificial intelligence character behavior by simulating vision for AIS controlled characters within a three-dimensional scene. That is, ray-tracing techniques which may often be used to render a two-dimensional image of a three-dimensional scene, may similarly be used by an AIS to determine what is seen by a character controlled by artificial intelligence. Thus, as ray-tracing may be used in image processing to determine what is within a field of view of the person who sees the final rendered two-dimensional image, an AIS may use ray-tracing to determine what is within a field of view or visibly surrounds a character within a three-dimensional scene. Furthermore, according to embodiments of the invention, the AIS may determine a response for the character based on what visibly surrounds the character within the three-dimensional scene. In contrast to artificial intelligence systems which may base character behavior on all objects within a three-dimensional scene, an AIS which uses ray-tracing to simulate vision for the character and bases character behavior on what is within a field of view of (i.e., what is seen by) the character may be more realistic.

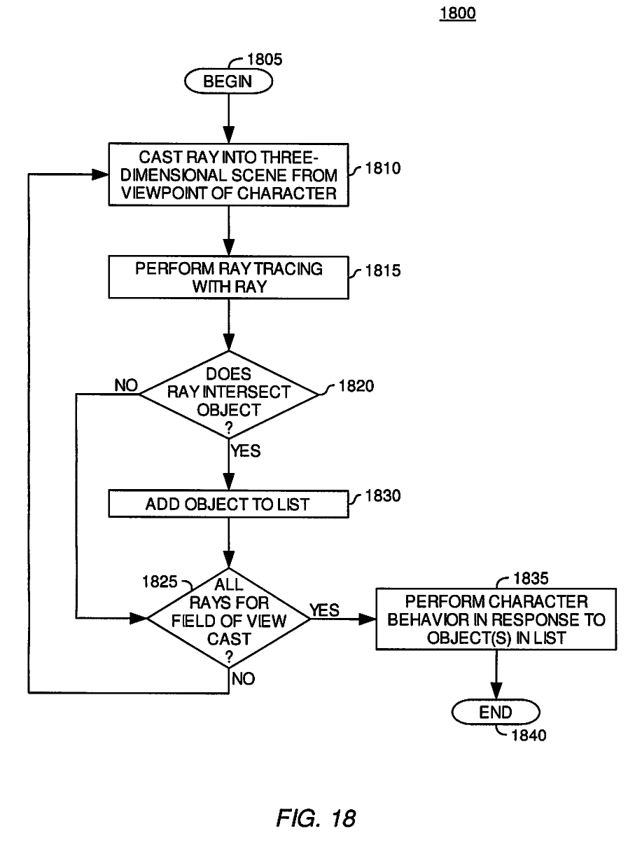

FIG. 18 is a flowchart which illustrates an exemplary method 1800 of using ray tracing to simulate vision and control the behavior of a character, according to one embodiment of the invention. The method 1800 may begin at step 1805, for example, when a character is placed or enters a three-dimensional scene. Next, at step 1810, the AIS may begin to simulate vision for the character by casting a ray into the three-dimensional scene from a viewpoint of the character. As the ray is cast into the three-dimensional scene, it may pass through a field of view which may control the amount of visible space the character can see. As described further below, the field of view may be made up of a plurality of blocks and the AIS may issue rays into the three-dimensional scene through the blocks. The AIS may follow a predetermined pattern when issuing the rays through the blocks through the field of view.

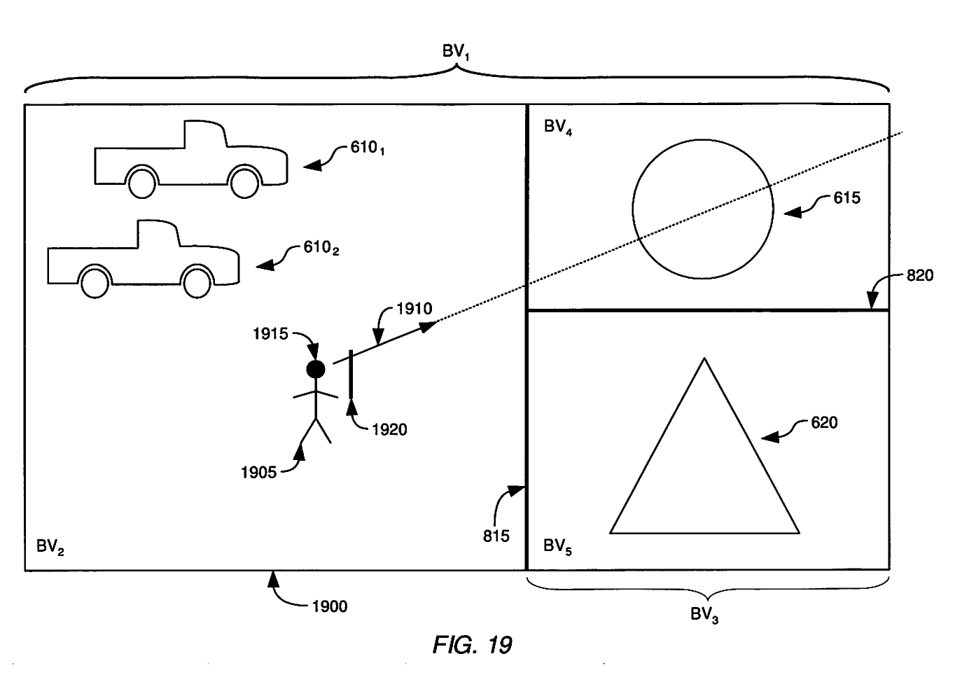

FIG. 19 illustrates an exemplary three-dimensional scene 1900 containing an AIS controlled character 1905. FIG. 19 is similar to the three-dimensional scene 605 illustrated in FIG. 8. However, in contrast to FIG. 8, FIG. 19 contains the character 1905. Consequently, FIG. 19 may be partitioned similar to the three-dimensional scene 605 illustrated FIG. 8. However, a spatial index (e.g., integrated acceleration data structure, kd-tree, etc.) which partitions FIG. 19 may contain additional information regarding the character 1905.

FIG. 19 also illustrates a ray 1910 being cast into the three-dimensional scene 1900 as described above with respect to step 1810. The ray may be cast into the three-dimensional scene (originate) from a viewpoint 1915. In order to make the artificial vision for the character as realistic as possible, the ray 1910 may be cast from a viewpoint 1915 close to the head or eyes of the character 1910. For example, as illustrated in FIG. 19, the ray 1910 originates from a viewpoint 1915 close to the head of the character 1905.

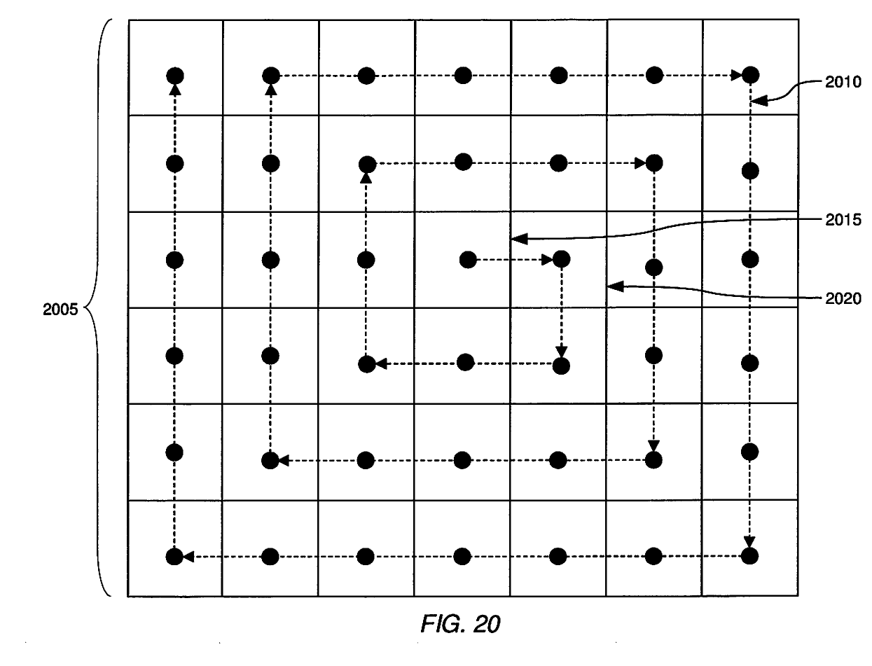

As the ray 1910 is cast into the three-dimensional scene, the ray 1910 may pass through a field of view 1920. FIG. 20 illustrates an exemplary grid of blocks 2005 which may make up all or a portion of a field of view. The grid of blocks 2005 may be similar to a frame or grid of pixels 330 as described above with regards to FIG. 3. Rays issued by the AIS may pass through the grid of blocks 2005 and, thus, through the field of view when issued into the three-dimensional scene. As illustrated, each block contains a darkened circle. The darkened circle corresponds to a location where a ray may pass through the block as the ray is issued into the three-dimensional scene by the AIS. Although the location is illustrated in the center of the block (i.e., a darkened circle in the center of each block), according to other embodiments of the invention, the ray may pass through a different location within or on the border of the block.

Furthermore, FIG. 20 illustrates an exemplary pattern 2010 which an AIS system may follow when issuing rays into a three-dimensional scene (e.g., the three-dimensional scene 1900 of FIG. 19), according to one embodiment of the invention. The exemplary pattern 2010 which an AIS may follow in issuing rays into the three-dimensional scene 605 is illustrated by the dashed arrow lines flowing throughout the grid of blocks 2005. According to one embodiment of the invention, the pattern 2010 starts at the center-most block 2015 and moves outwardly in a concentric pattern when issuing rays through blocks. Thus, an AIS which may issue a single ray into the three-dimensional scene 605 for each block may issue the first ray into the three-dimensional scene 605 through the center-most block 2015. Next the AIS following the pattern 2010 illustrated in FIG. 20 may issue a second ray through the block immediately to the right of the center-most block (ie., block 2020). The AIS may continue to issue one ray per block along the dashed line representing the pattern 2010 until the AIS has issued one ray per block for every block in the field of view 2010. Moreover, in other embodiments of the invention the AIS may issue a different number of rays per block, or may follow a different pattern.

Returning to FIG. 18, after issuing a ray into the three-dimensional scene, at step 1815 the AIS may perform ray tracing with the ray. The AIS may perform ray tracing with the ray similar to how an image processing system may perform ray tracing as described above with respect to FIG. 4. That is, the AIS may use a spatial index (e.g., integrated acceleration data structure, kd-tree, etc.) to trace the ray through the three-dimensional scene. The spatial index may contain nodes corresponding to bounding volumes which partition the three-dimensional scene. The AIS may take branches to nodes in the spatial index which correspond to bounding volumes intersected by the ray. The AIS may take branches to nodes until a leaf node containing primitives is reached, or in the case of an integrated acceleration data structure, until an object node is reached. Then the AIS may perform ray-primitive or ray-object intersection tests to determine if the ray intersects a primitive or an object within the three-dimensional scene. Furthermore, if the ray intersects a primitive or an object within the three-dimensional scene, the AIS may issue secondary rays from the point of intersection to determine other color or illumination contributed to the intersected object (e.g., as described above with respect to FIG. 3).

The three-dimensional scene (e.g., the three-dimensional scene 1900 illustrated in FIG. 19) may have been partitioned by the image processing system or some other system prior to the AIS commencing the method 1800. For example, the physics engine or the image processing system may have created the spatial index for physics simulation purposes or image processing purposes, respectively. Those systems may have stored the spatial index in a memory location accessible by the AIS (e.g., memory cache 110). Consequently, the AIS may use the same spatial index which was created by another system. By using the spatial index created by another system, the AIS may reduce the amount of space required to store a data structure to be used when determining character behavior.

While performing ray tracing with the initial ray, or after performing ray-tracing with the initial ray, at step 1820 the AIS may determine whether or not the ray intersected any objects within the three-dimensional scene. If not, the AIS may proceed to step 1825 to determine if all rays have been issued into the three-dimensional scene and whether or not to issue additional rays into the three-dimensional scene. However, if the AIS determines that the ray intersects an object within the three-dimensional scene, the AIS may proceed to step 1830 to add the intersected object to a list of intersected objects. The list of intersected objects may be used to accumulate an indication of every object which is intersected by at least one ray issued through the frame of view. Thus, the list of intersected objects may be considered a list of objects which are visible to the AIS controlled character (e.g., visible to the character 1905 illustrated in FIG. 19) For example, the AIS may determine at step 1820 that the initial ray 1910 illustrated in FIG. 19 may intersect the circle object 615, consequently at step 1830 the AIS may add the circle object 615 to the list.

After adding an object to the list, at step 1825, the AIS may determine if all rays have been cast into the three-dimensional scene for the field of view. For example, as illustrated in FIG. 20, all rays may be cast for a field of view when a single ray has been cast for each block in the grid of blocks. If all rays have not been cast into the three-dimensional scene for the field of view, the AIS may return to step 1810 to issue another ray into the three-dimensional scene through the field of view.

However, if all rays have been cast into the three-dimensional scene for the field of view, the AIS may proceed to step 1835 to perform a character behavior in response to the intersected objects. The AIS may perform a character behavior in response to the intersected objects by evaluating the object or objects within the list of objects. According to one embodiment of the invention, the AIS may evaluate all of the objects within the list and may select a single object which to respond to with a character behavior. However, according to other embodiments of the invention the AIS may select multiple objects to respond to with a character behavior, or may respond to objects by doing nothing.

If the AIS determines a response to an object or objects intersected by rays issued by the AIS is appropriate or necessary, the AIS may perform a behavior (e.g., a predetermined behavior) in response to the object. For example, the AIS may move the AIS controlled character away from the object, or the AIS may move the character towards the object. After responding to an object or objects, the AIS may proceed to step 1840 to end the method 1800.

For example, the AIS may determine that the circle object 615 may be a destination or an objective for the character. Consequently, at step 1820 the AIS may perform a character behavior response to the circle object 615 by moving the character 1905 towards the circle object 615. However, in other circumstances the AIS may determine that the circle object 615 is to be avoided by the character and, consequently, may move the character 1905 away from the circle object 615.

By issuing rays through the field of view, the AIS may determine if objects or which objects can be seen by or are visible to a character controlled by the AIS. Furthermore, by adding the intersected (visible) objects to a list, the AIS use the list to determine a character behavior to perform in response to the visible objects.

According to another embodiment of the invention, the AIS may alter the position of the field of view of the character over time to determine if other objects within the three-dimensional scene can be seen by the character. That is, the AIS may pan the three-dimensional scene by keeping the viewpoint the same but changing the field of view and, thus, changing the trajectory of rays issued into the three-dimensional scene. Consequently, the character may issue more rays into the scene which may intersect more objects within the three-dimensional scene. Altering the position of the field of view over time may be thought of as the AIS turning the head of a character over time to view or see a larger portion of the three-dimensional scene.

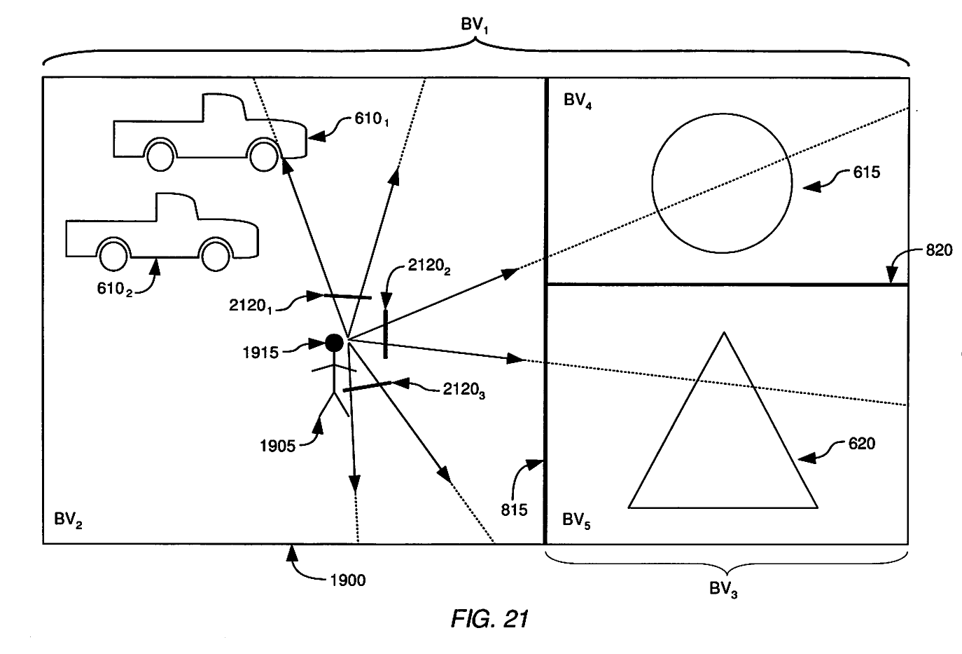

For example, FIG. 21 illustrates the three-dimensional scene 1900 described above with regards to FIG. 19. However, in FIG. 21 the AIS has altered the field of view multiple times to increase the amount of the three-dimensional scene the character 1905 can see. For example, the AIS may have issued a plurality of rays through a first position of the field of view 2120₁, through a second plurality of rays through a second position of the field of view 2120₂, and through a third position of the field of view 2120₃. The paths of the outermost rays issued through each position of each field of view are illustrated in FIG. 21 by the dashed lines following the rays. The area between each pair of outermost rays may contain objects which may be intersected by rays issued by the AIS (i.e., may be seen by the AIS controlled character). By issuing rays through the three fields of view (ie., 2120₁, 2120₂, and 2120₃) the character may see more objects within the three-dimensional scene.

For example, as illustrated in FIG. 21 rays issued through the first field of view 2120₁ are likely to intersect the first car object 610₁, and rays issued through the second field of view 2120₂ are likely to intersect the circle object 615 and the triangle object 620. However, rays issued through the third-field of view 2120₃ are not likely to intersect any objects. Consequently rays may intersect three of the four objects within the three-dimensional scene 1900 and, thus, the character may see more objects by issuing rays through multiple fields of view than issuing rays through a single position of the field of view (e.g., as illustrated in FIG. 19).

The number of positions for the field of view over time may be determined by the amount of workload required to perform ray-tracing (e.g., number of calculations) for each field of view. However, according to embodiments of the invention, the number of rays issued through each position of the field of view may be decreased in response to an increase in the number of positions for the field of view. By decreasing the number of rays issued through each field of view, the AIS may offset the increase in workload associated with increasing the number of positions for the field of view.

Furthermore, by reducing the number of rays issued through a field of view when the AIS alters the field of view, the AIS may realistically simulate human vision by reducing the likelihood of a ray intersecting an object in the three-dimensional scene. That is, in reality when a human pans a scene or alters their perspective over time, the likelihood of the human not seeing or noticing an object within the scene is increased. Similarly, reducing the number of rays cast into the three-dimensional scene by the AIS when altering the field of view over time may reduce the likelihood a ray will intersect an object within the three-dimensional scene. Thus, the AIS realistically simulates human vision for the character by reducing the number of rays cast through the field of view when altering the field of view for the character over time.

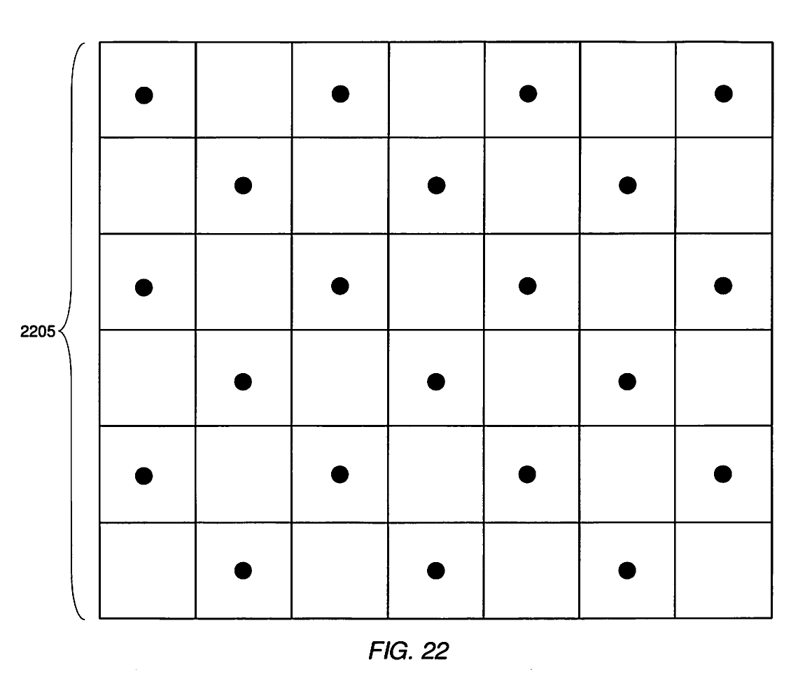

FIG. 22 illustrates an exemplary grid of blocks 2205 which may make up a portion of or an entire field of view. The darkened circles within certain blocks illustrate locations where rays issued by the AIS pass through the field of view. As illustrated in FIG. 22, rays are issued through every other block within the grid of blocks 2205. Thus, fewer rays are issued into the grid of blocks 2205 than through the field of view or grid of blocks illustrated above in FIG. 20. Consequently, a workload to perform ray tracing with the rays issued through the grid of blocks 2205 illustrated in FIG. 22 is likely to be less than a workload to perform ray tracing with rays issued through the grid of blocks 2200 illustrated in FIG. 20. Thus, The AIS may reduce workload when altering the field of view over time and increase realism by issuing fewer rays into the three-dimensional scene using a pattern similar to the pattern illustrated in FIG. 22.

Although embodiments of the invention (e.g., method 1800) indicate an AIS may perform character behavior in response to objects within the three-dimensional scene after all rays have been issued through a field of view, other embodiments of the invention may be devised which may perform a character behavior in response to objects within the three-dimensional scene before all rays have been issued through a field of view.

### Conclusion

According to embodiments of the invention, an artificial intelligence system may use ray-tracing to simulate vision for a character within a three-dimensional scene. Furthermore, according to embodiments of the invention, the artificial intelligence system may determine and control the behavior of the character in response to objects which are seen by the character. By simulating vision for a character and controlling the behavior of the character based on objects which are seen, an artificial intelligence system may better simulate human-like behavior for a character within a three-dimensional scene.

While the foregoing is directed to embodiments of the present invention, other and further embodiments of the invention may be devised without departing from the basic scope thereof, and the scope thereof is determined by the claims that follow.

What is claimed is:

1. A method of using ray-tracing for artificial intelligence, comprising:
issuing an initial plurality of rays into a three-dimensional scene from a viewpoint of a character;
tracing the initial plurality of rays through the three-dimensional scene; and
controlling the behavior of the character based on results of tracing the initial plurality of rays through the three-dimensional scene.

2. The method of claim 1, wherein tracing the initial plurality of rays through the three-dimensional scene comprises:
providing a spatial index having branches and nodes corresponding to bounding volumes which partition the three-dimensional scene; and
taking branches to nodes corresponding to bounding volumes intersected by rays in the initial plurality of rays.

3. The method of claim 1, wherein the initial plurality of rays are issued into the three-dimensional scene through a field of view.

4. The method of claim 3, wherein the field of view comprises a plurality of blocks organized in a grid, and wherein a single ray of the plurality of rays is issued into the three-dimensional view through each block in the field of view.

5. The method of claim 3, further comprising
altering the position of the field of view to at least one new position; and
issuing a second plurality of rays into the three-dimensional scene, wherein the second plurality of rays are issued into the three-dimensional view through the new positions of the field of view.

6. The method of claim 5, wherein the initial plurality of rays contains more rays than the second plurality of rays.

7. The method of claim 1, wherein at least one ray in the initial plurality of rays intersects an object; and wherein controlling the behavior of the character comprises performing an action with the character based on the intersected object.

8. The method of claim 7, wherein performing an action with the character comprises moving the character.

9. A computer readable medium containing a program which, when executed, performs operations comprising:
issuing an initial plurality of rays into a three-dimensional scene from a viewpoint of a character;
tracing the initial plurality of rays through the three-dimensional scene; and
controlling the behavior of the character based on results of tracing the initial plurality of rays through the three-dimensional scene.

10. The computer readable medium of claim 9, wherein tracing the initial plurality of rays through the three-dimensional scene comprises:
providing a spatial index having branches and nodes corresponding to bounding volumes which partition the three-dimensional scene; and
taking branches to nodes corresponding to bounding volumes intersected by rays in the initial plurality of rays.

11. The computer readable medium of claim 9, wherein the initial plurality of rays are issued into the three-dimensional scene through a field of view.

12. The computer readable medium of claim 11, wherein the field of view comprises a plurality of blocks organized in a grid, and wherein a single ray of the plurality of rays is issued into the three-dimensional view through each block in the field of view.

13. The computer readable medium of claim 11, wherein the operations further comprise:
altering the position of the field of view to at least one new position; and
issuing a second plurality of rays into the three-dimensional scene, wherein the second plurality of rays are issued into the three-dimensional view through the new positions of the field of view.

14. The computer readable medium of claim 13, wherein the initial plurality of rays contains more rays than the second plurality of rays.

15. The computer readable medium of claim 9, wherein at least one ray in the initial plurality of rays intersects an object; and wherein controlling the behavior of the character comprises performing an action with the character based on the intersected object.

16. An artificial intelligence system, comprising:
a memory device containing a spatial index having nodes corresponding to bounding volumes which partition a three-dimensional scene; and
a processing element configured to issue an initial plurality of rays into the three-dimensional scene from a viewpoint of a character, trace the initial plurality of rays through the three-dimensional scene; and control the behavior of the character based on results of tracing the initial plurality of rays through the three-dimensional scene.

17. The artificial intelligence system of claim 16, wherein the processing element is configured to trace the initial plurality of rays through the three-dimensional scene by providing a spatial index having branches and nodes corresponding to bounding volumes which partition the three-dimensional scene, and taking branches to nodes corresponding to bounding volumes intersected by rays in the initial plurality of rays.

18. The artificial intelligence system of claim 9, wherein the initial plurality of rays are issued into the three-dimensional scene through a field of view.

19. The artificial intelligence system of claim 18, wherein the field of view comprises a plurality of blocks organized in a grid, and wherein a single ray of the plurality of rays is issued into the three-dimensional view through each block in the field of view.

20. The artificial intelligence system of claim 18, wherein processing element is further configured to:
alter the position of the field of view to at least one new position; and
issue a second plurality of rays into the three-dimensional scene, wherein the second plurality of rays are issued into the three-dimensional view through the new positions of the field of view.
